(19) United States
(12) Patent Application Publication
(10) Pub. No.: US 2026/0031565 A1
(43) Pub. Date: Jan. 29, 2026

(54) CONNECTOR ASSEMBLY

(71) Applicant: Bellwether Electronic Corp., Taoyuan City (TW)

(72) Inventors: Hsing-Yu LEE, Taoyuan City (TW); Ching-Hsiang CHANG, Taoyuan City (TW)

(21) Appl. No.: 19/079,477

(22) Filed: Mar. 14, 2025

Related U.S. Application Data
(60) Provisional application No. 63/676,444, filed on Jul. 29, 2024.

(30) Foreign Application Priority Data
Nov. 12, 2024 (TW) 113143439

(51) Int. Cl. H01R 13/502; H01R 13/627; H01R 13/633; H01R 13/639; H01R 103/00

(52) U.S. Cl. CPC H01R 13/502; H01R 13/6272; H01R 13/6335; H01R 13/639; H01R 2103/00

(57) ABSTRACT

A connector assembly includes a first connector and a second connector coupled to the first connector. The first connector includes a first bottom plate, first side plates, and a first conductive terminal. The first side plates and the first bottom plate jointly define an accommodating space. The first conductive terminal passes through the first bottom plate and extends in the accommodating space. The second connector includes a second bottom plate, second side plates, and a second conductive terminal. The second plates and the second bottom plate form at least one cavity. The second conductive terminal is located in the at least one cavity. The second conductive terminal includes a contacting portion and a connecting portion connected to the contacting portion. The contacting portion has a hollowed portion. The first conductive terminal enters the hollowed portion and is electrically connected to the second conductive terminal.

### CROSS-REFERENCE TO RELATED APPLICATION

This application claims priority to U.S. Provisional Application Ser. No. 63/676,444 filed Jul. 29, 2024, and Taiwan Application Serial Number 113143439, filed Nov. 12, 2024, the disclosures of which are incorporated herein by reference in their entireties.

### BACKGROUND

### Field of Invention

The present invention relates to a connector assembly, especially a connector assembly that can transmit large current.

### Description of Related Art

Generally, connectors are used to realize repeated electrical connection and disconnection between cables and circuit boards. For example, a connector may be connected with a wire, and another connector may be mounted on a circuit board end that matches the connector located at the wire side.

However, with the increasing demand for the conducting large current, the quantity and weight of the cables also increase. Nevertheless, the installation space available for the system is limited, which restricts the cable-end connector and the board-end connector to conduct larger current within a smaller space. Therefore, how to enhance the conducting capacity of the cable-end connector and the board-end connector within a limited space will be a problem that needs to be addressed.

Therefore, how to propose a connector assembly that can solve the aforementioned problems is one of the problems that the industry is currently eager to invest in research and development resources to solve.

### SUMMARY

In view of this, one purpose of the present disclosure is to provide a connector assembly that can solve the aforementioned problems.

In order to achieve the above objective, in accordance with an embodiment of the present disclosure, a connector assembly includes a first connector and a second connector configured to be coupled to the first connector. The first connector includes a first bottom plate, a plurality of first side plates, and a first conductive terminal. The first side plates surround and are connected to sides of the first bottom plate. The first side plates and the first bottom plate jointly define an accommodating space. The first conductive terminal is fixed to the first bottom plate and extends along a first direction in the accommodating space. The second connector is partially accommodated in the accommodating space. The second connector includes a second bottom plate, a plurality of second side plates, and a second conductive terminal. The second side plates surround and are connected to sides of the second bottom plate. The second side plates and the second bottom plate form at least one cavity. The second conductive terminal is located in the at least one cavity and extends along the first direction. The second conductive terminal includes a contacting portion and a connecting portion connected to the contacting portion. The contacting portion has a hollowed portion. The first conductive terminal is able to enter the hollowed portion to be electrically connected to the second conductive terminal. The connecting portion is tabular and is parallel to a central axis of the hollowed portion.

In one or more embodiments of the present disclosure, the second connector further includes at least one partitioning portion located between opposite two of the second side plates. The at least one partitioning portion extends along the first direction.

In one or more embodiments of the present disclosure, the connector assembly further includes a plug detachable combined with one of the second side plates. The contacting portion of the second conductive terminal is located between the plug and the second bottom plate.

In one or more embodiments of the present disclosure, one of the first side plates has an opening. The second connector further includes an engaging part disposed on one of the second side plates. The engaging part is located on an outer side of the opening and is engaged with the opening as the second connector is coupled to the first connector.

In one or more embodiments of the present disclosure, the first connector further includes a sill located at an end of one of the first side plates away from the first bottom plate. The sill is located on a side of the opening.

In one or more embodiments of the present disclosure, an outer surface of the sill is lower than an outer surface of the one of the first side plates.

In one or more embodiments of the present disclosure, the engaging part includes a pressing portion, an elastic arm, and a hook. The pressing portion and the hook are located at two ends of the elastic arm.

In one or more embodiments of the present disclosure, a width of the pressing portion is greater than a width of the elastic arm.

In one or more embodiments of the present disclosure, the connector assembly further includes a pull belt passing through the second connector. The pull belt includes a binding portion binding the pressing portion of the engaging part, a pull tab located out of the second connector, and a strip portion connected between the binding portion and the pull tab and winding inward and outward the second connector.

In one or more embodiments of the present disclosure, the first conductive terminal includes a locking portion. The locking portion is a recess portion. The first connector includes at least one plug entering the locking portion.

In one or more embodiments of the present disclosure, the first bottom plate has a hole. The hole has a diameter varying along the first direction to secure the first conductive terminal.

In one or more embodiments of the present disclosure, the first bottom plate has a hole. A plurality of convex bars are located on an inner surface of the hole to secure the first conductive terminal.

In one or more embodiments of the present disclosure, the second connector further includes a crown spring. The crown spring is disposed in the hollowed portion of the contacting portion of the second conductive terminal.

In one or more embodiments of the present disclosure, the second connector further includes a cover plate. The cover plate is connected to a portion of the second side plates, such that the second conductive terminal is secured between the cover plate and the second bottom plate.

In one or more embodiments of the present disclosure, the first connector further includes another first conductive terminal fixed to the first bottom plate and extending in the accommodating space along the first direction. The second connector further includes another second conductive terminal located in the at least one cavity and extending along the first direction.

In one or more embodiments of the present disclosure, the first connector further includes a pocket portion disposed on one of the first side plates. The pocket portion protrudes from the one of the first side plates. The second connector further includes an engaging part disposed on one of the second side plates. The engaging part is engaged with the pocket portion.

In order to achieve the above objective, in accordance with an embodiment of the present disclosure, a connector assembly includes a first connector and a second connector configured to be coupled to the first connector. The first connector includes a first bottom plate, a plurality of the first side plates, and two first conductive terminals. The first bottom plate has two holes. The first side plates surround and are connected to sides of the first bottom plate. The first side plates and the first bottom plate jointly define an accommodating space. The two conductive terminals respectively pass through the two holes of the first bottom plate and extend in the accommodating space along a first direction. One of the first side plates, which is wider than at least another one of the first side plates, has an opening. The second connector is partially accommodated in the accommodating space. The second connector includes a second bottom plate, a plurality of second side plates, two second conductive terminals, and an engaging part. The second bottom plate abuts against the first bottom plate and has two holes. The second side plates surround and are connected to sides of the second bottom plate. The second side plates and the second bottom plate form at least one cavity. The two second conductive terminals are located in the at least one cavity. Each of the two second conductive terminals includes a contacting portion and a connecting portion connected to the contacting portion. The connecting portion is configured to be electrically connected to a cable. The contacting portion has a hollowed portion. The two first conductive terminals are able to enter the hollowed portions to be electrically connected to the two second conductive terminals. The engaging part is disposed on one of the second side plates. The engaging part is engaged with the opening.

In one or more embodiments of the present disclosure, the first connector further includes a sill located on a side of the opening. An outer surface of the sill is lower than an outer surface of the one of the first side plates.

In one or more embodiments of the present disclosure, the connecting portion is tabular. The connecting portion is parallel to a central axis of the hollowed portion.

In one or more embodiments of the present disclosure, a first portion of the at least one cavity extends along the first direction. A second portion of the at least one cavity extends along a second direction different from the first direction.

In one or more embodiments of the present disclosure, the connecting portion is tabular. The connecting portion is perpendicular to a central axis of the hollowed portion.

In one or more embodiments of the present disclosure, the contacting portion of each of the two second conductive terminals is located in the first portion of the at least one cavity. The connecting portion of each of the two second conductive terminals is located in the second portion of the at least one cavity.

In one or more embodiments of the present disclosure, the at least another one of the first side plates has at least one convex rib disposed on an inner surface thereof.

In one or more embodiments of the present disclosure, the connector assembly further includes a pull belt passing through the second connector. The pull belt includes a binding portion binding a pressing portion of the engaging part, a pull tab located out of the second connector, and a strip portion connected between the binding portion and the pull tab and winding inward and outward the second connector.

In summary, in the connector assembly of the present disclosure, since a terminal main body of the first conductive terminal passes through the hole of the first bottom plate and a width of a blocking portion is greater than the width of the hole, the first conductive terminal is fixed to the hole. In the connector assembly of the present disclosure, since the convex bars are disposed on the inner surface of a channel of the first bottom plate and the convex bars abut against the terminal main body of the first conductive terminal, the first conductive terminal can be prevented from being disengaged from the first bottom plate as the second connector is pulled out by an external force. In the connector assembly of the present disclosure, since the engaging part of the second connector is engaged with the opening of the first connector, the second connector is less likely to be disengaged from the first connector when being coupled to each other. In the connector assembly of the present disclosure, since the sill is located on the first side plate and communicates with the opening and a thickness of the sill is less than a thickness of the first bottom plate, the size of the second connector can be smaller. The engaging part can more easily enter the opening through the relatively lower sill as the second connector is coupled to the first connector, thereby achieving a purpose of easier assembling while ensuring the strengthening of the fixation between the two connectors. In the connector assembly of the present disclosure, since the connector assembly includes a plug, the plug blocks the movement of the second conductive terminal in an extending direction of the second conductive terminal to be disengaged from the second connector. In the connector assembly of the present disclosure, since the first conductive terminal includes a locking portion between the expanding portion and the blocking portion, and the width of the plug is less than that of the locking portion, the plug can clamp the locking portion. In summary, the connector assembly of the present disclosure not only reduces the size of the connector but also enables the transmission of larger current, but also achieves the effect of stabilizing the structure of the entire connector assembly.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view of a connector assembly in accordance with an embodiment of the present disclosure;

FIG. 2A is a perspective view of a first connector in accordance with an embodiment of the present disclosure;

FIG. 2B is a perspective view of the first connector in accordance with an embodiment of the present disclosure;

FIG. 3 is a perspective view of a second connector in accordance with an embodiment of the present disclosure;

FIG. 4 is an exploded view of the second connector in accordance with an embodiment of the present disclosure;

FIG. 5 is a cross-sectional view of the connector assembly in accordance with an embodiment of the present disclosure;

FIG. 6 is a cross-sectional view of the connector assembly in accordance with an embodiment of the present disclosure;

FIG. 7 is a perspective view of a connector assembly in accordance with an embodiment of the present disclosure;

FIG. 8 is a perspective view of a first connector and a plug in accordance with an embodiment of the present disclosure;

FIG. 9 is an exploded view of the first connector in accordance with an embodiment of the present disclosure;

FIG. 10 is an exploded view of the connector assembly in accordance with another embodiment of the present disclosure;

FIG. 11 is a cross-sectional view of the connector assembly in accordance with an embodiment of the present disclosure;

FIG. 12 is a cross-sectional view of the connector assembly in accordance with an embodiment of the present disclosure;

FIG. 13 is a perspective view of a connector assembly in accordance with an embodiment of the present disclosure;

FIG. 14 is a perspective view of a first connector in accordance with an embodiment of the present disclosure;

FIG. 15 is an exploded view of the first connector in accordance with an embodiment of the present disclosure;

FIG. 16 is a cross-sectional view of the connector assembly in accordance with an embodiment of the present disclosure;

FIG. 17 is a perspective view of a connector assembly in accordance with an embodiment of the present disclosure;

FIG. 18 is an exploded view of the connector assembly in accordance with an embodiment of the present disclosure;

FIG. 19 is a perspective view of a first connector in accordance with an embodiment of the present disclosure;

FIG. 20 is a cross-sectional view of the connector assembly in accordance with an embodiment of the present disclosure;

FIG. 21 is a cross-sectional view of the connector assembly in accordance with an embodiment of the present disclosure;

FIG. 22 is a perspective view of a connector assembly in accordance with an embodiment of the present disclosure;

FIG. 23 is an exploded view of the connector assembly in accordance with an embodiment of the present disclosure;

FIG. 24 is a cross-sectional view of the connector assembly in accordance with an embodiment of the present disclosure; and

FIG. 25 is a cross-sectional view of the connector assembly in accordance with an embodiment of the present disclosure.

### DETAILED DESCRIPTION

Hereinafter, a plurality of embodiments of the present disclosure will be disclosed in diagrams. For the sake of clarity, many details in practice will be described in the following description. However, it should be understood that these details in practice should not limit present disclosure. In other words, in some embodiments of present disclosure, these details in practice are unnecessary. In addition, for simplicity of the drawings, some conventionally used structures and elements will be shown in a simple schematic manner in the drawings. The same reference numbers are used in the drawings and the description to refer to the same or like parts.

Hereinafter, the structure and function of each component included in a connector assembly 100 of this embodiment and the connection relationship between the components will be described in detail.

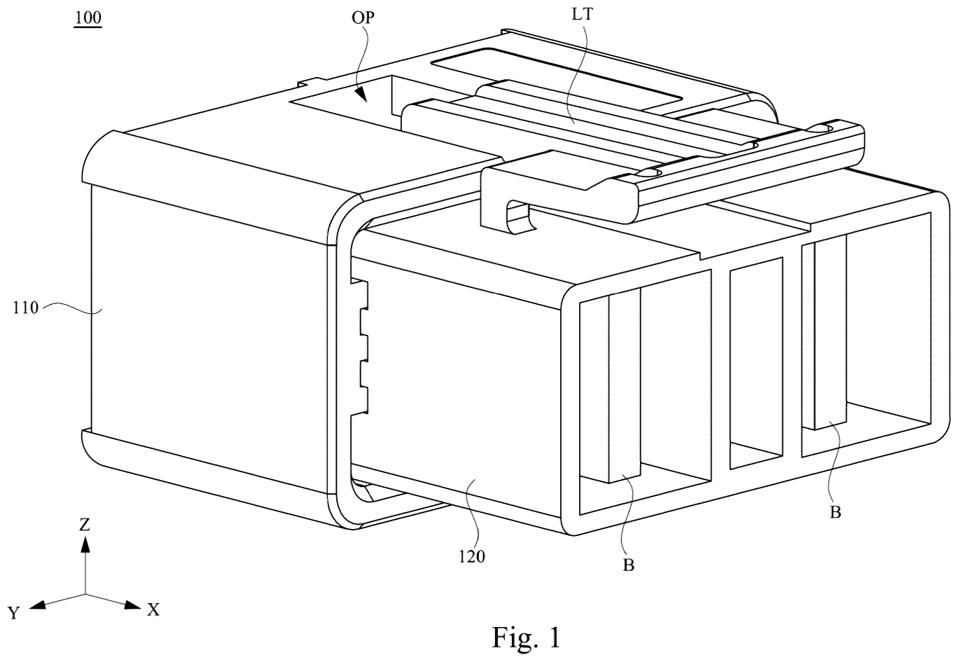

Reference is made to FIG. 1. FIG. 1 is a perspective view of a connector assembly in accordance with an embodiment of the present disclosure. As shown in FIG. 1, in this embodiment, the connector assembly 100 includes a first connector 110 and a second connector 120. The second connector 120 can be coupled to the first connector 110. Specifically, the first connector 110 has a space configured to accommodate the second connector 120. The first connector 110 includes an opening OP on a surface of the first connector 110. The second connector 120 includes an engaging part LT located on a surface of the second connector 120. As shown in FIG. 1, the engaging part LT is located on an outer side of the opening OP and engaged with the opening OP. In other words, the second connector 120 is fixed to the first connector 110 by the engaging part LT coupled to the opening OP. In a usage scenario, the first connector 110 and the second connector 120 are coupled to each other along a direction (e.g., x-direction). In this embodiment, the second connector 120 further includes a second conductive terminal B. Specifically, the second connector 120 has a space configured to accommodate the second conductive terminal B. In some embodiments, the second connector 120 includes two (or more) second conductive terminals B. The two second conductive terminals B are arranged in a direction (e.g., y-direction).

In some embodiments, the first connector 110 is a board-side connector. In some embodiments, the second connector 120 is a cable-side connector.

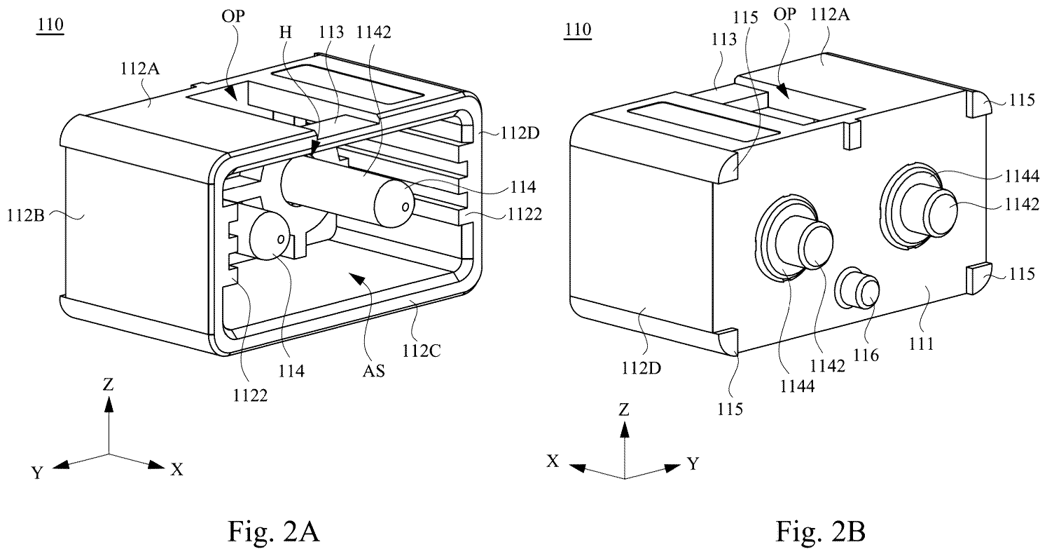

Reference is made to FIG. 2A and FIG. 2B. FIG. 2A and FIG. 2B are perspective views of the first connector 110 in accordance with an embodiment of the present disclosure. As shown in FIG. 2A and FIG. 2B, in this embodiment, the first connector 110 is an upright board-side connector vertically mounted on a circuit board (not depicted) and includes an insulating housing and a first conductive terminal 114. The insulating housing includes a first bottom plate 111, four first side plates 112A, 112B, 112C, and 112D, a sill 113, a mesa 115, and a positioning post 116. The four first side plates 112A, 112B, 112C, and 112D are disposed on four sides of the first bottom plate 111. Specifically, the four first side plates 112A, 112B, 112C, and 112D surround and are connected to the four sides of the first bottom plate 111. The first side plate 112A and the first side plate 112C are opposite to each other, and the first side plate 112B and the first side plate 112D are opposite to each other. A width of the first side plate 112A (in y-direction) is greater than a width of the first side plate 112B (in z-direction). The first side plate 112A, the first side plate 112B, the first side plate 112C, the first side plate 112D, and the first bottom plate 111 jointly define an accommodating space AS. The sill 113 is located at an end of the first side plate 112A away from the first bottom plate 111. The sill 113 is located on a side of the opening OP. Specifically, the first side plate 112A and the sill 113 surround the opening OP. In x-direction, the surface of the first side plate 112A is leveled with a surface of the sill 113. In some embodiments, in z-direction, a thickness of the sill 113 is less than a thickness of the first side plate 112A, such that an outer surface of the sill 113 is lower than an outer surface of the first side plate 112A.

Reference is made again to FIG. 2A and FIG. 2B. In this embodiment, the first conductive terminal 114 partially passes through the first bottom plate 111, extends in the accommodating space AS along a direction (e.g., x-direction), and is parallel to the four first side plates 112A, 112B, 112C, and 112D. Specifically, the first bottom plate 111 has a hole H running therethrough, and the first conductive terminal 114 passes through the hole H of the first bottom plate 111 in x-direction to be fixed to the first bottom plate 111 and perpendicular to the first bottom plate 111. The first conductive terminal 114 includes a terminal main body 1142 and a blocking portion 1144. The blocking portion 1144 is disposed on the terminal main body 1142, and the blocking portion 1144 surrounds the terminal main body 1142, such that two ends of the terminal main body 1142 are located on opposite sides of the blocking portion 1144. Specifically, the blocking portion 1144 is located in a middle section of the terminal main body 1142, and the blocking portion 1144 matches the hole H (or, the blocking portion 1144 is slightly larger than the hole H), such that the blocking portion 1144 can be fixed in the hole H. An end of the terminal main body 1142 is located in the accommodating space AS, whereas the other end of the terminal main body 1142 is exposed on an outer surface of the first bottom plate 111, so as to be electrically connected to the circuit board.

As shown in FIG. 2B, in some embodiments, the blocking portion 1144 is located on a bottom side of the terminal main body 1142. The terminal main body 1142 extends in the accommodating space AS along a direction (e.g., x-direction). In some embodiments, the first connector 110 includes two (or more) first conductive terminals 114, and the two first conductive terminals 114 are arranged in a direction (e.g., y-direction). The mesa 115 is disposed at a corner of the first bottom plate 111 and protrudes from the outer surface of the first bottom plate 111. The positioning post 116 is disposed on the first bottom plate 111 and protrudes from the outer surface of the first bottom plate 111. A protruding length of the positioning post 116 is longer than that of the mesa 115. The positioning post 116 and the mesa 115 are separated from each other. In some embodiments, the positioning post 116 may be disposed on and protrude from the mesa 115. In some embodiments, the blocking portion 1144, the mesa 115, and the positioning post 116 are located on the same side of the first bottom plate 111. In a usage scenario, the mesa 115 is configured to form a gap between the first bottom plate 111 and the circuit board (not depicted), and the positioning post 116 is configured to position the first connector 110 on the circuit board (not depicted) by entering a position hole of the circuit board.

Reference is made again to FIG. 2A and FIG. 2B. As shown in FIG. 2A and FIG. 2B, in this embodiment, the first connector 110 further includes at least one convex rib 1122. The convex rib 1122 can be disposed on at least one of the four first side plates 112A, 112B, 112C, and 112D. In this embodiment, a plurality of convex ribs 1122 are disposed on opposing inner surfaces of the first side plate 112B and the first side plate 112D. The convex ribs 1122 are located in the accommodating space AS. In some embodiments, the convex ribs 1122 extend along a direction (e.g., x-direction) and are arranged in a direction (e.g., z-direction). In some embodiments, the convex ribs 1122 are separated from the opening OP. In some embodiments, the convex ribs 1122 are eccentrically disposed, i.e., a distance between the first side plate 112A and a nearest one of the convex ribs 1122 relative to the first side plate 112A is less than a distance between the first side plate 112C and a nearest one of the convex ribs 1122 relative to the first side plate 112C. This arrangement prevents the second connector 120 from being inserted into the first connector 110 in an incorrect orientation, thereby achieving a mistake-proofing effect. Additionally, the convex ribs 1122 can enhance the structural strength of the insulating housing of the first connector 110.

In some embodiments, the terminal main body 1142 may, for example, be cylindrical. In some embodiments, the blocking portion 1144 may, for example, be disk-shaped. However, the present disclosure does not intend to limit the shapes of the terminal main body 1142 and the blocking portion 1144.

In some embodiments, the first connector 110 may have a substantially rectangular cuboid shape. However, the present disclosure does not intend to limit the shape of the first connector 110.

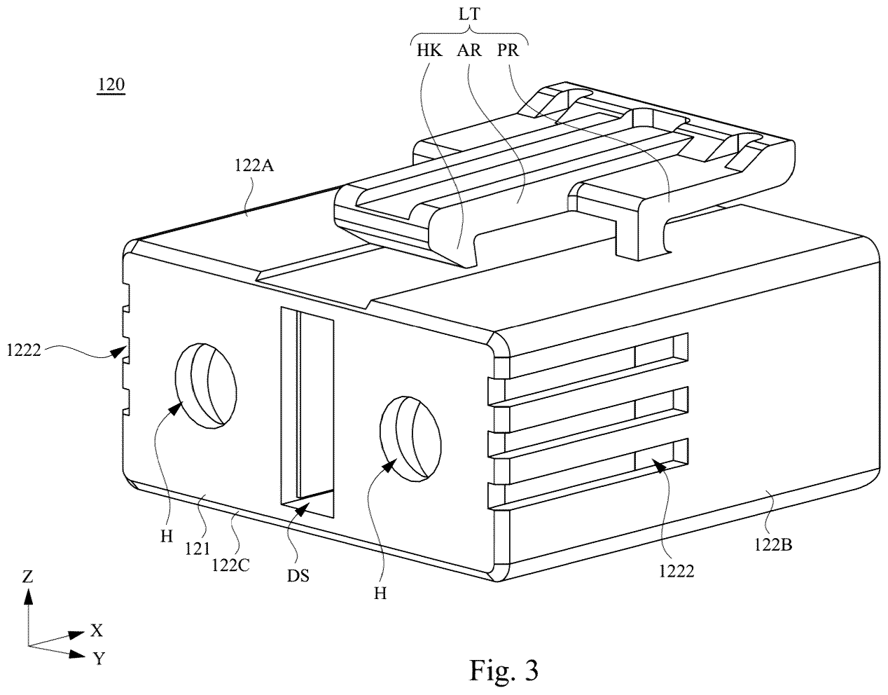

Reference is made to FIG. 3. FIG. 3 is a perspective view of a second connector 120 in accordance with an embodiment of the present disclosure. As shown in FIG. 3, in this embodiment, the second connector 120 is a straight-exit connector and includes a second bottom plate 121, and four second side plates 122A, 122B, 122C, and 122D. The four second side plates 122A, 122B, 122C, and 122D are disposed on four sides of the second bottom plate 121.

Specifically, the four second side plates 122A, 122B, 122C, and 122D surround and are connected to the four sides of the second bottom plate 121. The second side plate 122A and the second side plate 122C are opposite to each other, and the second side plate 122B and the second side plate 122D are opposite to each other. The four second side plates 122A, 122B, 122C, and 122D and the second bottom plate 121 form at least one cavity. Reference is also made to FIG. 1 and FIG. 3. When the first connector 110 is coupled to the second connector 120, portions of the four second side plates 122A, 122B, 122C, and 122D are accommodated in the accommodating space AS surrounded by the four first side plates 112A, 112B, 112C, and 112D. In other words, the second connector 120 is partially enclosed by the first connector 110, so that the coupling between the first connector 110 and the second connector 120 is more stable. As shown in FIG. 3, in this embodiment, the engaging part LT includes a pressing portion PR, an elastic arm AR, and a hook HK. The engaging part LT is engaged with the opening OP of the first connector 110 by the hook HK. The pressing portion PR is disposed over the second side plate 122A. The pressing portion PR and the hook HK are located at both ends of the elastic arm AR. Specifically, the pressing portion PR is located at an end of the engaging part LT away from the opening OP, whereas the hook HK is located at an inner surface of an end the engaging part LT close to the opening OP. In other words, the elastic arm AR is connected between the hook HK and the pressing portion PR. The place where the elastic arm AR connects the pressing portion PR is connected to an outer surface of the second side plate 122A by two supporting posts, so that the pressing portion PR and the hook HK seesaw relative to the second side plate 122A. In y-direction, a width of the pressing portion PR is greater than a width of the elastic arm AR, so that users press the pressing portion PR with more convenience. As shown in FIG. 3, in this embodiment, the second connector 120 further has a hole H and a dissipation path DS. The hole H and the dissipation path DS run through the second bottom plate 121.

Reference is made again to FIG. 3. As shown in FIG. 3, in this embodiment, the second connector 120 further includes a plurality of grooves 1222. The grooves 1222 of the second connector 120 correspond to the convex ribs 1122 of the first connector 110. The grooves 1222 are disposed on the second side plate 122B and the second side plate 122D opposite to each other. In some embodiments, the grooves 1222 extend in a direction (e.g., x-direction) and are arranged in a direction (e.g., z-direction). In some embodiments, the grooves 1222 are separated from the engaging part LT. In some embodiments, the grooves 1222 are eccentrically disposed.

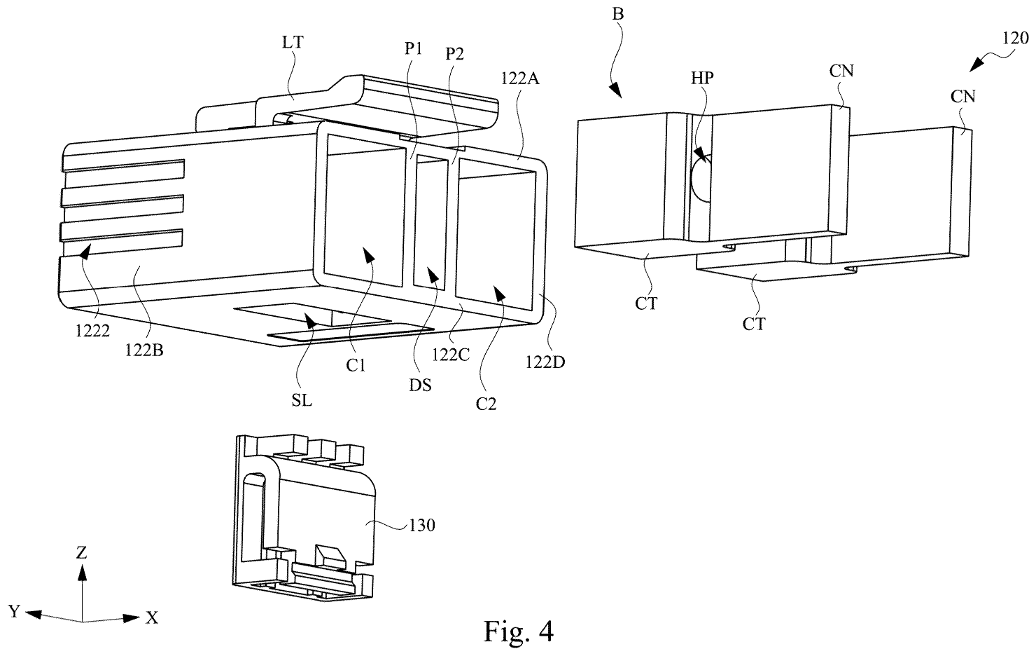

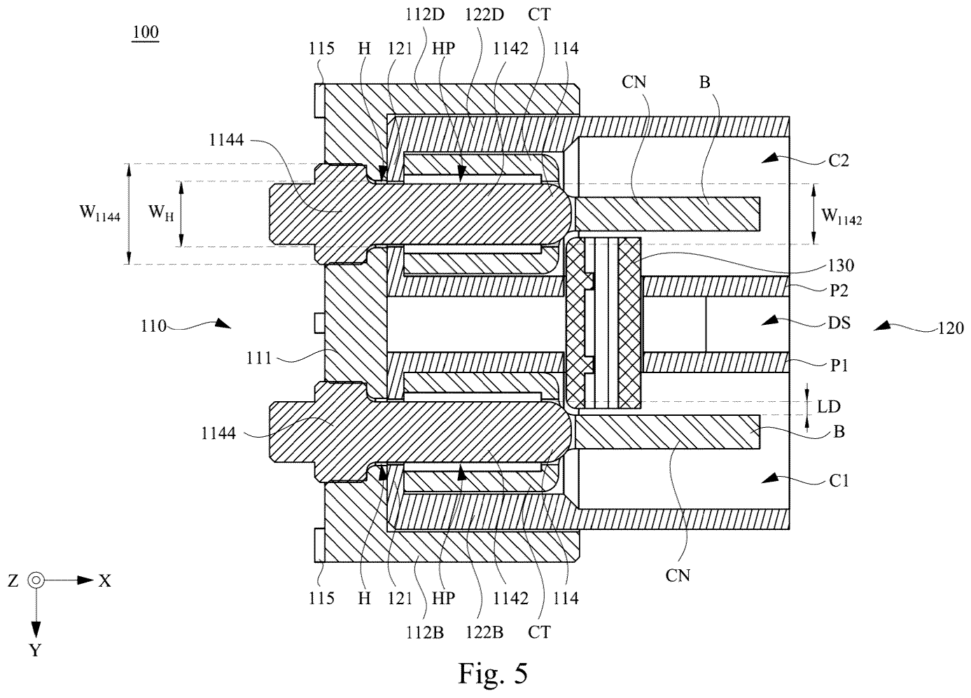

Reference is made to FIG. 4. FIG. 4 is an exploded view of the second connector 120 in accordance with an embodiment of the present disclosure. As shown in FIG. 4, in this embodiment, the second connector 120 further includes a partitioning portion P1 and a partitioning portion P2. The partitioning portion P1 and the partitioning portion P2 are located between the second side plate 122A and the second side plate 122C opposite to each other. The partitioning portion P1, the partitioning portion P2, the second side plate 122B, and the second side plate 122D extend in parallel. The second side plate 122A, the second side plate 122B, the second side plate 122C, and the partitioning portion P1 jointly define a first cavity C1. The second side plate 122A, the partitioning portion P1, the second side plate 122C, and the partitioning portion P2 jointly define the dissipation path DS. The second side plate 122A, the partitioning portion P2, the second side plate 122C, and the second side plate 122D jointly define a second cavity C2. In this embodiment, two second conductive terminals B are respectively located in the first cavity C1 and the second cavity C2 and extend in a direction (e.g., x-direction). The second conductive terminal B includes a contacting portion CT and a connecting portion CN. The connecting portion CN is connected to the contacting portion CT. The contacting portion CT and the connecting portion CN are arranged in extending directions of the first cavity C1 and the second cavity C2, so that a width (e.g., z-direction) of the second connector 120 in a direction perpendicular to an extending direction of the second conductive terminal B can be designed to be less. The contacting portion CT is located at an end of the second conductive terminal B close to the second bottom plate 121, whereas the connecting portion CN is located at an end of the second conductive terminal B away from the second bottom plate 121 and is configured to connect a cable (not depicted). An outgoing direction of the cable is perpendicular to the second bottom plate 121. The contacting portion CT is generally rectangular-cuboidal and has a hollowed portion HP. The hollowed portion HP may be cylindrical and extends along x-direction (i.e., a central axis of the hollowed portion HP is parallel to x-direction). The connecting portion CN is tabular and is parallel to the central axis of the hollowed portion HP. Plane surfaces of two sides of the connecting portion CN are configured to be electrically connected to the cable. An end of the connecting portion CN is connected to the contacting portion CT, and a width of the connecting portion CN in z-direction may be less than or equal to a width of the contacting portion CT in z-direction, such that a width of the second connector 120 in z-direction to be less. Referring to FIG. 5, a thickness of the connecting portion CN is less than a thickness of the contacting portion CT, such that a step LD is formed at the place where the connecting portion CN and the contacting portion CT connect. In some embodiments, a shape of the hollowed portion HP matches a shape of a portion of the first conductive terminal 114. In a usage scenario, the first conductive terminal 114 of the first connector 110 penetrates the hollowed portion HP and is electrically connected to the second conductive terminal B.

Reference is made again to FIG. 4. As shown in FIG. 4, in this embodiment, the second connector 120 further includes a plug 130. The plug 130 is detachably combined with the second connector 120. Specifically, the second connector 120 has a slot SL. The slot SL runs through the second side plate 122C of the second connector 120. More specifically, the slot SL is disposed on the second side plate 122C and passes through the partitioning portion P1 and the partitioning portion P2 in y-direction. In some embodiments, the plug 130 is located in the slot SL and portions of the plug 130 exposed by the first cavity C1 and the second cavity C2. In a usage scenario, after the two second conductive terminals B are respectively inserted into the first cavity C1 and the second cavity C2, the plug 130 is inserted into the slot SL along a direction (e.g., z-direction) and combined with the second connector 120. At the moment, the plug 130 will block the steps LD (referring to FIG. 5) of the two second conductive terminals B, such that the two second conductive terminals B are fixed in the first cavity C1 and the second cavity C2 of the second connector 120.

Reference is made to FIG. 5. FIG. 5 is a cross-sectional view of the connector assembly 100 in accordance with an embodiment of the present disclosure. As shown in FIG. 5, in this embodiment, the second connector 120 is coupled to the first connector 110, and the second connector 120 is partially located in the accommodating space AS of the first connector 110. The second bottom plate 121 abuts against or is close to the first bottom plate 111. The first conductive terminal 114 passes through both the hole H of the second bottom plate 121 and enters the hollowed portion HP of the second conductive terminal B. The terminal main body 1142 has a width W₁₁₄₂ in a direction (e.g., y-direction). In some embodiments in which the terminal main body 1142 is cylindrical, the width W₁₁₄₂ of the terminal main body 1142 is a diameter of the terminal main body 1142. The blocking portion 1144 has a width W₁₁₄₄ in a direction (e.g., y-direction). In some embodiments in which the blocking portion 1144 is disk-shaped, the width W₁₁₄₄ of the blocking portion 1144 is a diameter of the blocking portion 1144. The hole H on an inner surface of the first bottom plate 111 has a minimum width W_{H} in a direction (e.g., y-direction). In some embodiments in which the hole H is circular, the minimum width W_{H} of the hole H on the inner surface of the first bottom plate 111 is a minimum diameter of the hole H. In other words, the hole H has two different diameters in x-direction, i.e., the diameter of the hole H on the outer surface of the first bottom plate 111 is greater than the diameter of the hole H on the inner surface of the first bottom plate 111. As shown in FIG. 5, in some embodiments, the width W₁₁₄₂ of the terminal main body 1142 is less than the width W₁₁₄₄ of the blocking portion 1144 and is also less than the minimum width W_{H} of the hole H. In some embodiments, the width W₁₁₄₄ of the blocking portion 1144 is greater than the minimum width W_{H} of the hole H on the first bottom plate 111. This allows the first conductive terminal 114, along x-direction, to be inserted into the hole H from an outer side of the insulating housing. After an end of the first conductive terminal 114 enters the accommodating space AS, the blocking portion 1144 is blocked and fixed on the hole H, so that the other end of the first conductive terminal 114 is exposed at the outer side of the insulating housing.

Reference is made again to FIG. 5. As shown in FIG. 5, in this embodiment, the dissipation path DS is located between the first cavity C1 and the second cavity C2. As shown in FIG. 5, the plug 130 is adjacent to the step LD of the second conductive terminal B in a direction (e.g., x-direction). Specifically, the plug 130 is located between two connecting portions CN, and a distance between the two connecting portions CN is approximately equal to a width of the plug 130 in y-direction. However, a width of the contacting portion CT in y-direction is greater than a width of the connecting portion CN in y-direction. Therefore, when the plug 130 is combined with the second connector 120, the plug 130 will be adjacent to the step LD of the second conductive terminal B in x-direction, so that the second conductive terminal B is blocked by the plug 130 and unable to exit from the first cavity C1 or the second cavity C2, thereby fixing the contacting portion CT between the second bottom plate 121 and the plug 130.

In some embodiments, when the second connector 120 is coupled to the first connector 110, the hole H of the first bottom plate 111, the hole H of the second bottom plate 121, and the hollowed portion HP of the second conductive terminal B are aligned in a direction (e.g., x-direction).

In some embodiments, the second connector 120 further includes a crown spring (not depicted) disposed in the hollowed portion HP of the contacting portion CT of the second conductive terminal B. When the second connector 120 is coupled to the first connector 110, the crown spring surrounds the terminal main body 1142, and the contacting portion CT surrounds the crown spring, such that the contacting portion CT is electrically connected to the terminal main body 1142.

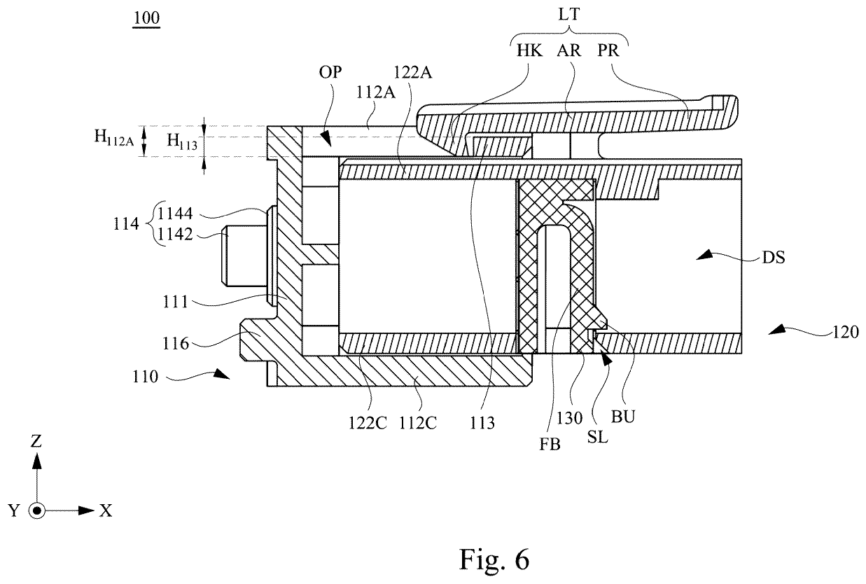

Reference is made to FIG. 6. FIG. 6 is a cross-sectional view of the connector assembly 100 in accordance with an embodiment of the present disclosure. As shown in FIG. 6, in this embodiment, the second connector 120 is coupled to the first connector 110, and the plug 130 is combined with the second connector 120. The first side plate 112A has a thickness H_{112A} in a direction (e.g., z-direction). The sill 113 has a thickness H₁₁₃ in a direction (e.g., z-direction). In some embodiments, the thickness H₁₁₃ of the sill 113 is less than the thickness H_{112A} of the first side plate 112A. This ensures that the hook HK of the engaging part LT can more easily cross the sill 113 and enter the opening OP during the coupling process of the second connector 120 and the first connector 110. In other words, the width of the second connector 120 in the z-direction can be designed to be less. Similarly, a height of the engaging part LT on the second side plate 122A of the second connector 120 can also be designed to be less, such that the overall size of the connector assembly 100 can be reduced. As shown in FIG. 6, the plug 130 is U-shaped. An elastic arm FB is on a side of the plug 130. A bump BU is on an outer side of a free end of the elastic arm FB. When the plug 130 is located in the slot SL, the bump BU is located on and adjacent to an inner side of the second side plate 122C. This allows the plug 130 to be securely fixed in the second connector 120. When the user presses the elastic arm FB, the bump BU moves away from the inner surface of the second side plate 122C and allows the user to pull the plug 130 out of the slot SL.

Hereinafter, the structure and function of each component included in a connector assembly 200 of this embodiment and the connection relationship between the components will be described in detail.

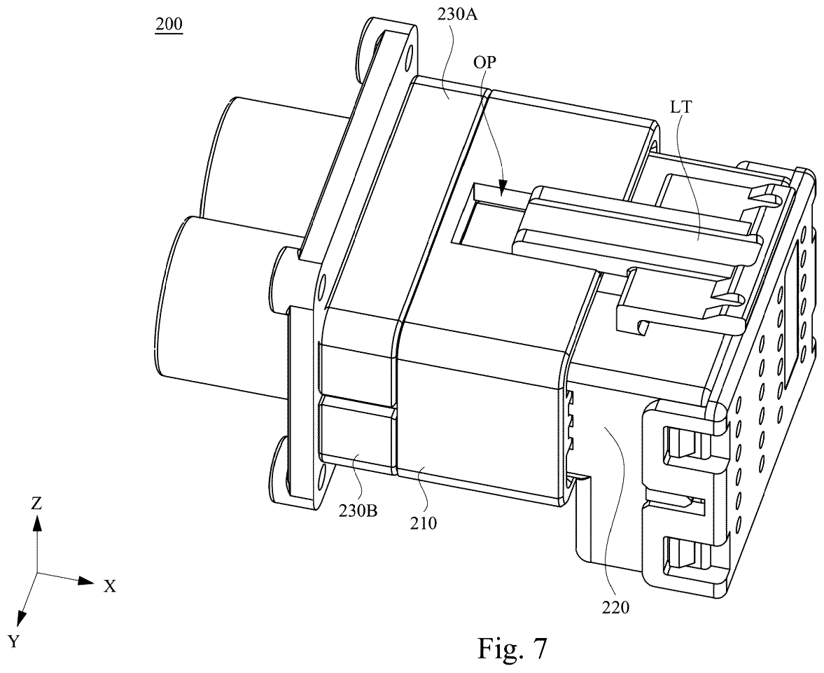

Reference is made to FIG. 7. FIG. 7 is a perspective view of a connector assembly 200 in accordance with an embodiment of the present disclosure. As shown in FIG. 7, in this embodiment, the connector assembly 200 includes a first connector 210 and a second connector 220. The second connector 220 can be coupled to the first connector 210. Specifically, the first connector 210 has a space configured to accommodate the second connector 220. In some embodiments, the first connector 210 is a straight-exit cable-end connector. In some embodiments, the second connector 220 is also a side-exit cable-end connector. The differences between this embodiment and the aforementioned embodiment are described below.

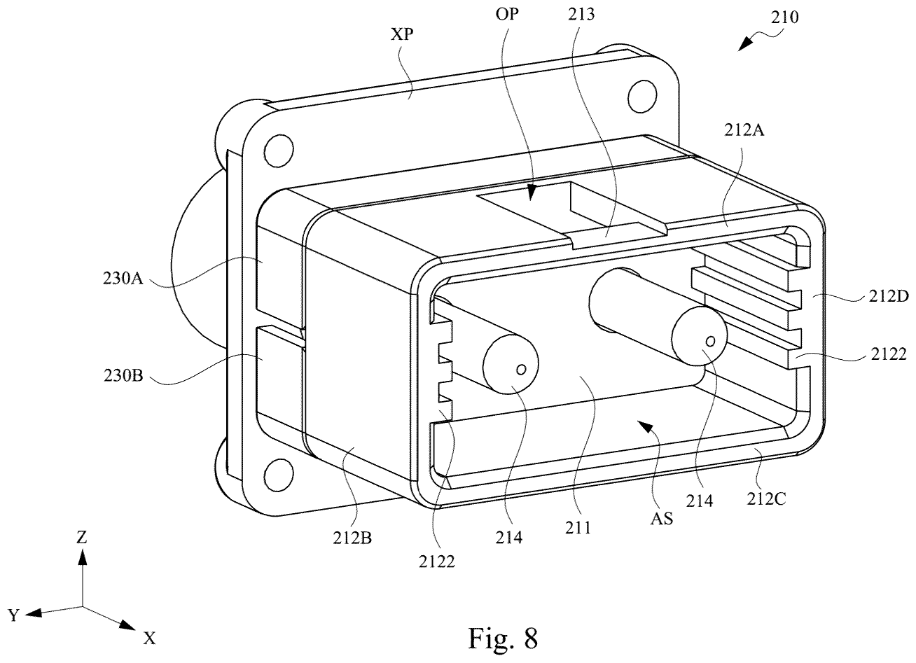

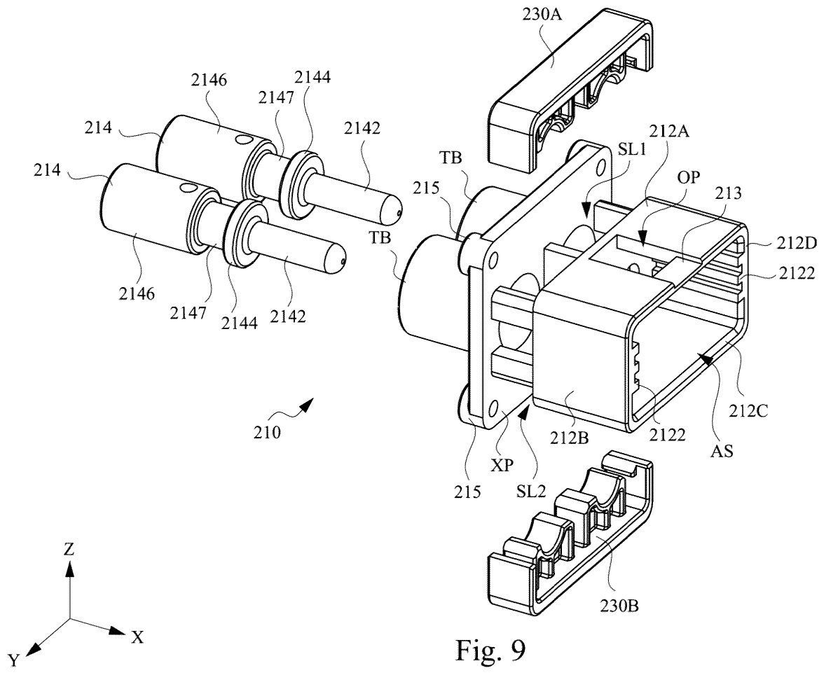

Reference is made to FIG. 8 and FIG. 9. FIG. 8 is a perspective view of a first connector 210 in accordance with an embodiment of the present disclosure. FIG. 9 is an exploded view of the first connector 210 in accordance with an embodiment of the present disclosure. In this embodiment, the first connector 210 further includes a fixing plate XP, a mesa 215, and a tube TB. The fixing plate XP is separated from the first bottom plate 211. The fixing plate XP and the first bottom plate 211 define the slot SL1 and the slot SL2 therebetween. The slot SL1 and the slot SL2 are respectively configured to allow the plug 230A and the plug 230B to be inserted. The mesa 215 is disposed at the corner of the fixing plate XP. The tube TB is disposed on a side of the fixing plate XP away from the plug 230A or the plug 230B. The tube TB is configured to accommodate the first conductive terminal 214. In a usage scenario, the mesa 215 of the fixing plate XP can be secured to any plane (e.g., wall, table, circuit board, or other suitable surface) by using additional fasteners (e.g., screws). In some embodiments, the mesa 215 and the tube TB are located on the same side of the fixing plate XP.

Reference is made again to FIG. 9. As shown in FIG. 9, in this embodiment, the first conductive terminal 214 further includes a terminal main body 2142, a blocking portion 2144, an expanding portion 2146, and a locking portion 2147. The blocking portion 2144 is disposed on the terminal main body 2142, and the blocking portion 2144 surrounds the terminal main body 2142. Specifically, the blocking portion 2144 is located at the middle section of the terminal main body 2142. In some embodiments, the expanding portion 2146 is located at a bottom end of the first conductive terminal 214. The expanding portion 2146 is separated from the blocking portion 2144 and has a hollowed hole (not depicted). The expanding portion 2146 is configured to connect a cable (not depicted) by inserting one end of the cable into the hollowed hole, and the cable penetrates outward from the tube TB. The expanding portion 2146 and the blocking portion 2144 define the locking portion 2147 therebetween. In other words, the locking portion 2147 is located between the blocking portion 2144 and the expanding portion 2146.

In some embodiments, the terminal main body 2142, the expanding portion 2146, and the locking portion 2147 may be, for example, cylindrical. In some embodiments, the blocking portion 2144 may be disc-shaped. A diameter of the locking portion 2147 is less than a diameter of the blocking portion 2144 and is also less than a diameter of the expanding portion 2146. In other words, the locking portion 2147 of the first conductive terminal 214 is a recess portion. However, the present disclosure does not intend to limit the shape of the terminal main body 2142, the blocking portion 2144, the expanding portion 2146, and the locking portion 2147.

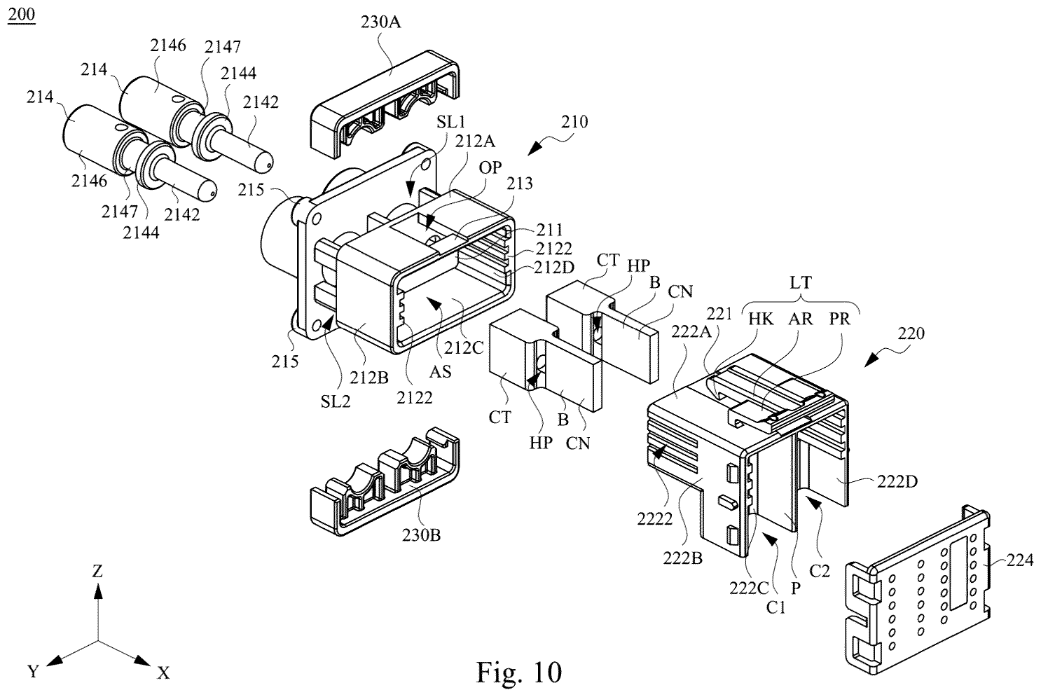

Reference is made to FIG. 10. FIG. 10 is an exploded view of the connector assembly 200 in accordance with another embodiment of the present disclosure. As shown in FIG. 10, in this embodiment, the second connector 220 includes a second bottom plate 221, and four second side plates 222A, 222B, 222C, and 222D. The four second side plates 222A, 222B, 222C, and 222D are disposed on four sides of the second bottom plate 221. The second side plate 222A and the second side plate 222C are opposite to each other, and the second side plate 222B and the second side plate 222D are opposite to each other. The second side plate 222A is generally tabular and parallel to x-y plane. The second side plate 222B and the second side plate 222D are generally tabular, are parallel to x-z plane, and reveal as an L shape in x-z plane. The second side plate 222C has two plane plates perpendicular to each other, and a projection of the second side plate 222C on x-z plane is L-shaped. The first plane plate portion of the second side plate 222C is parallel to the second side plate 222A and connected to the second bottom plate 221, whereas the second plane plate portion is away from the second bottom plate 221 and parallel to the second bottom plate 221.

As shown in FIG. 10, in this embodiment, the second connector 220 further includes a partitioning portion P. The partitioning portion P is located between the second side plate 222A and the second side plate 222C opposite to each other. The partitioning portion P, the second side plate 222B, and the second side plate 222D extend in parallel. The second side plate 222A, the second side plate 222B, the second side plate 222C, and the partitioning portion P jointly define a first cavity C1. The second side plate 222A, the partitioning portion P, the second side plate 222C, and the second side plate 222D jointly define a second cavity C2. In some embodiments, the partitioning portion P may be, for example, L-shaped. In some embodiments, a first portion of the first cavity C1 or the second cavity C2 extends in a direction (e.g., x-direction), and a second portion of the first cavity C1 or the second cavity C2 extends in a direction (e.g., z-direction). In other words, the first cavity C1 and the second cavity C2 are L-shaped. A contacting portion CT and a connecting portion CN of the second conductive terminal B are located in the first portion of the first cavity C1 or the second cavity C2. As shown in FIG. 10, in this embodiment, two second conductive terminals B are respectively located in the first cavity C1 and the second cavity C2 and extend in a direction (e.g., x-direction).

Reference is made again to FIG. 10. As shown in FIG. 10, in this embodiment, the second connector 220 further includes a cover plate 224. The cover plate 224 is connected to the second side plate 222A, the second side plate 222B, and the second side plate 222D, so as to secure the second conductive terminal B between the second bottom plate 221 and the cover plate 224. The cover plate 224 extends perpendicularly relative to the second side plate 222A, the second side plate 222B, and the second side plate 222D. The cover plate 224 is parallel to the second plane plate portion of the second side plate 222C, and a cable outlet port is formed between the second plane plate portion and the cover plate 224. The cable connected to the connecting portion CN of the second conductive terminal B and the second bottom plate 221 extend outward in parallel from the cable outlet port.

In some embodiments, the second side plate 222A, the second side plate 222B, the second side plate 222C, the partitioning portion P, and the cover plate 224 jointly define the first cavity C1. The second side plate 222A, the second side plate 222B, the second side plate 222D, the partitioning portion P, and the cover plate 224 jointly define the second cavity C2.

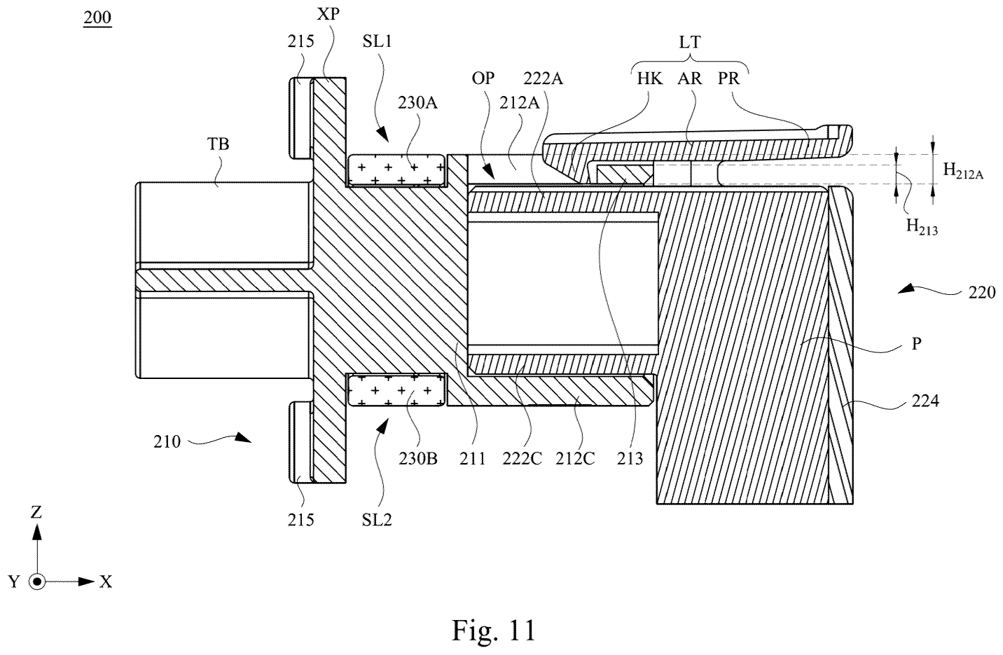

Reference is made to FIG. 11. FIG. 11 is a cross-sectional view of the connector assembly 200 in accordance with an embodiment of the present disclosure. As shown in FIG. 11, in this embodiment, the second connector 220 can be coupled to the first connector 210, and both of the plug 230A and the plug 230B are detachably combined to the first connector 210. Specifically, the plug 230A is accommodated in the slot SL1, and the plug 230B is accommodated in the slot SL2. In other words, the plug 230A and the plug 230B are located between the fixing plate XP and the first bottom plate 211. The first side plate 212A has a thickness H_{212A} in a direction (e.g., z-direction). The sill 213 has a thickness H₂₁₃ in a direction (e.g., z-direction). In some embodiments, the thickness H₂₁₃ of the sill 213 is less than the thickness H_{212A} of the first side plate 212A, so an outer surface of the sill 213 is lower than an outer surface of the first side plate 212A. This ensures that the hook HK of the engaging part LT can more easily cross over the sill 213 and enter the opening OP as the second connector 220 and the first connector 210 are combined toward each other. Therefore, the overall width of the connector assembly 200 in z-direction can be reduced.

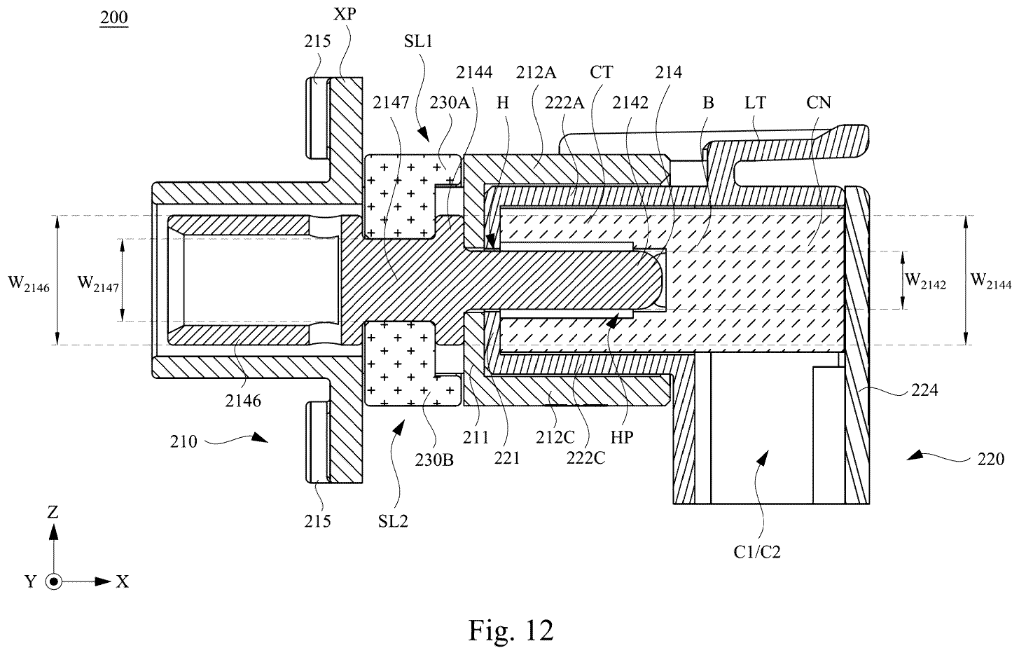

Reference is made to FIG. 12. FIG. 12 is a cross-sectional view of the connector assembly 200 in accordance with an embodiment of the present disclosure. As shown in FIG. 12, in this embodiment, the second connector 220 is coupled to the first connector 210, and a portion of the second connector 220 is located in the accommodating space AS of the first connector 210. The second bottom plate 221 is adjacent to the first bottom plate 211. The first conductive terminal 214 on the first connector 210 passes through the hole H of the second bottom plate 221 and enters the hollowed portion HP of the second conductive terminal B. The terminal main body 2142 has a width W₂₁₄₂ in a direction (e.g., y-direction). In some embodiments in which the terminal main body 2142 is cylindrical, the width W₂₁₄₂ is a diameter of the terminal main body 2142. The blocking portion 2144 has a width W₂₁₄₄ in a direction (e.g., y-direction). In some embodiments in which the blocking portion 2144 is disk-shaped, the width W₂₁₄₄ is a diameter of the blocking portion 2144. The expanding portion 2146 has a width W₂₁₄₆ in a direction (e.g., y-direction). In some embodiments in which the expanding portion 2146 is cylindrical, a width W₂₁₄₆ is a diameter of the expanding portion 2146. The locking portion 2147 has a width W₂₁₄₇ in a direction (e.g., y-direction). In some embodiments in which the locking portion 2147 is cylindrical, a width W₂₁₄₇ is a diameter of the locking portion 2147. The hole H of the first bottom plate 211 has a minimum width W_{H} in a direction (e.g., y-direction) on the inner surface of the first bottom plate 211. In some embodiments in which the hole H is circular, the minimum width W_{H} in a direction is a minimum diameter of the hole H. As shown in FIG. 12, in some embodiments, the minimum width W_{H} of the hole H on the inner surface of the first bottom plate 211 is less than the width W₂₁₄₄ of the blocking portion 2144. In some embodiments, the width W₂₁₄₇ of the locking portion 2147 is less than the width W₂₁₄₄ of the blocking portion 2144. In some embodiments, the width W₂₁₄₇ of the locking portion 2147 is less than the width W₂₁₄₆ of the expanding portion 2146. When the first conductive terminal 214 passes through and is secured to the first bottom plate 211, the locking portion 2147 is exposed at the slot SL1 and the slot SL2. At the moment, the plug 230A and the plug 230B are inserted into the slot SL1 and the slot SL2, respectively, so that the plug 230A and the plug 230B can clamp the locking portion 2147 to secure the first conductive terminal 214. In other words, portions of the plug 230A and the plug 230B are located between the blocking portion 2144 and the expanding portion 2146. In some embodiments, the plug 230A and the plug 230B abut against the blocking portion 2144 and the expanding portion 2146. In some embodiments, the plug 230A and the plug 230B interfere with the blocking portion 2144 and the expanding portion 2146 in x-direction. This prevents the first conductive terminal 214 exiting from the first connector 210 along the negative x-direction.

Hereinafter, the structure and function of each component included in a connector assembly 300 of this embodiment and the connection relationship between the components will be described in detail.

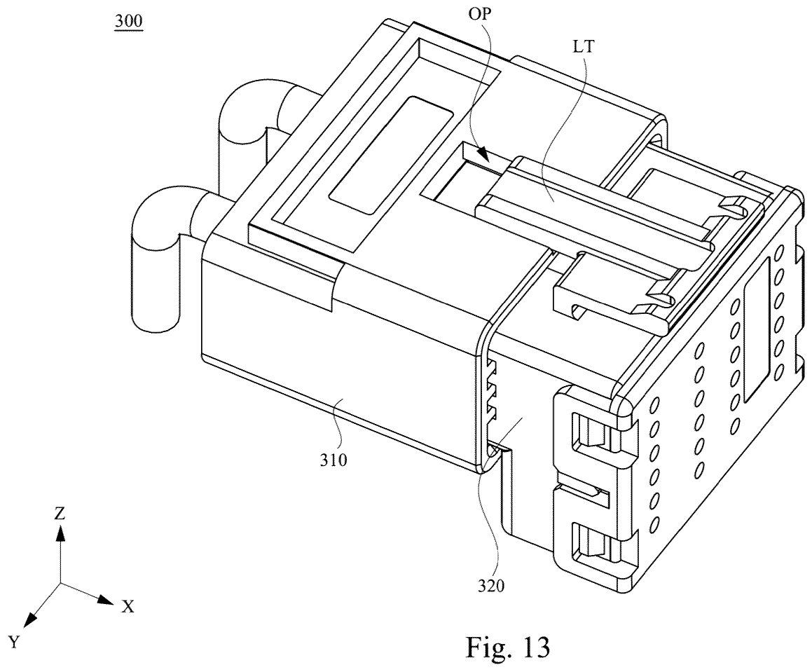

Reference is made to FIG. 13. FIG. 13 is a perspective view of a connector assembly 300 in accordance with an embodiment of the present disclosure. As shown in FIG. 13, in this embodiment, the connector assembly 300 includes a first connector 310 and a second connector 320. The second connector 320 can be coupled to the first connector 310. Since the structural configuration of the second connector 320 is identical to that of the second connector 220, further description is omitted here.

In some embodiments, the first connector 310 is a right-angle board-end connector. In some embodiments, the second connector 320 is a side-exit cable-end connector.

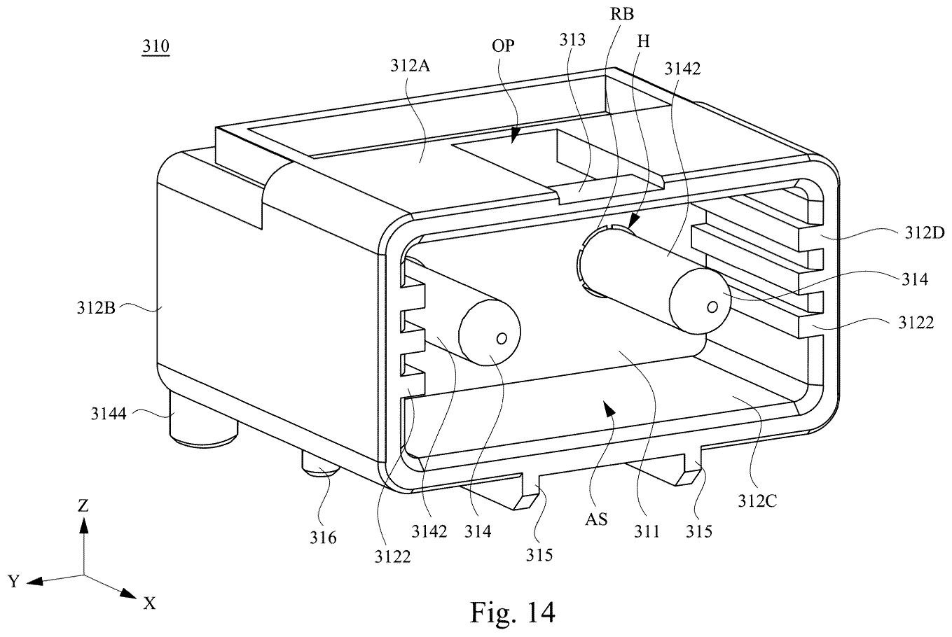

Reference is made to FIG. 14. FIG. 14 is a perspective view of a first connector 310 in accordance with an embodiment of the present disclosure. A first conductive terminal 314 includes a terminal main body 3142 and a bending portion 3144. The bending portion 3144 is connected to the terminal main body 3142. The terminal main body 3142 passes through a first bottom plate 311 and extends in an accommodating space AS along a direction (e.g., x-direction). Specifically, the first bottom plate 311 has a hole H, and the terminal main body 3142 passes through the hole H of the first bottom plate 311 and is secured to the first bottom plate 311. The bending portion 3144 is exposed out of the first bottom plate 311 and configured to be electrically connected to a circuit board. A mesa 315 is disposed on a first side plate 312C and protrudes from a surface of the first side plate 312C. A positioning post 316 is disposed on the mesa 315 and protrudes from the surface of the mesa 315. In some embodiments, the mesa 315 is elongated along a direction (e.g., x-direction). In some embodiments, the mesa 315 and the positioning post 316 are located on the same side of the first side plate 312C. In a usage scenario, the mesa 315 is configured to form a gap between the first bottom plate 311 and the circuit board (not depicted) and the positioning post 316 is configured to position the first connector 310 on the circuit board (not depicted).

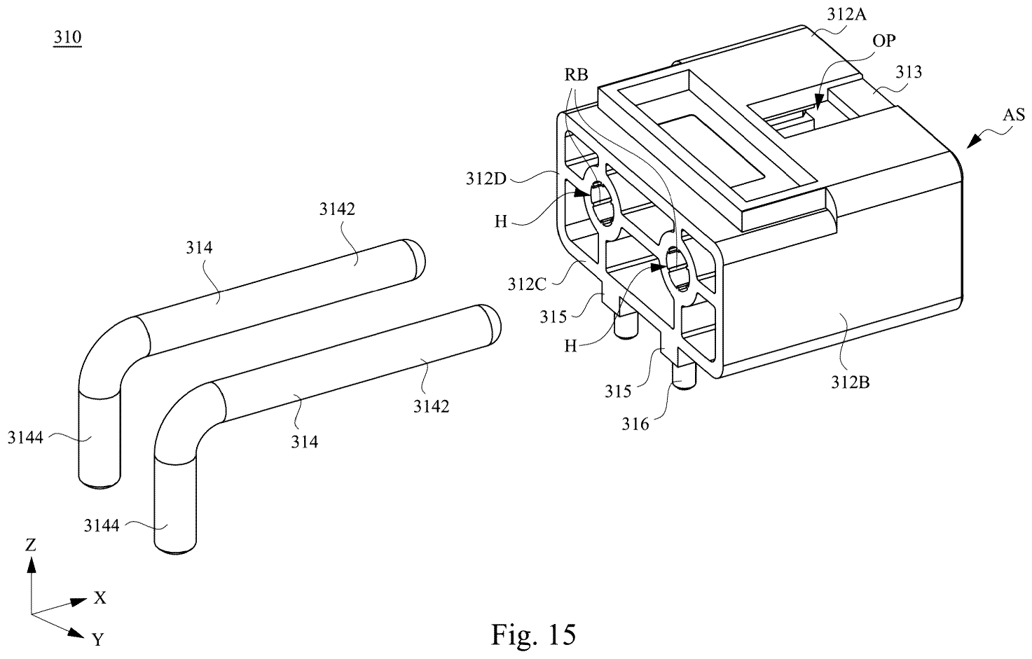

Reference is made to FIG. 15. FIG. 15 is an exploded view of the first connector 310 in accordance with an embodiment of the present disclosure. As shown in FIG. 15, a plurality of convex bars RB are on an inner surface of the hole H. The terminal main body 3142 passes through the hole H and slightly interferes with the convex bars RB. This allows the first conductive terminal 314 to be fixed on the first bottom plate 311. In some embodiments, the convex bars RB extend along a direction (e.g., x-direction). In this embodiment, the bending portion 3144 extends perpendicularly from the terminal main body 3142. In some embodiments, the bending portion 3144 is located at a bottom end of the terminal main body 3142. The terminal main body 3142 extends in the accommodating space AS along a direction (e.g., x-direction). The bending portion 3144 extends along a direction (e.g., z-direction).

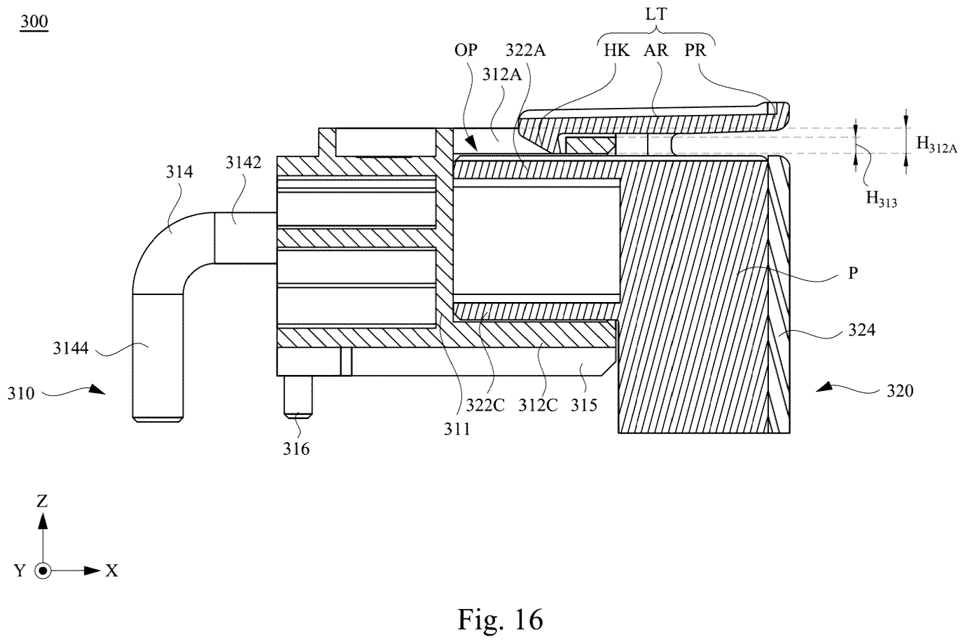

Reference is made to FIG. 16. FIG. 16 is a cross-sectional view of the connector assembly 300 in accordance with an embodiment of the present disclosure. As shown in FIG. 16, in this embodiment, the second connector 320 is coupled to the first connector 310. Specifically, a first side plate 312A has a thickness H_{312A} in a direction (e.g., z-direction). A sill 313 has a thickness H₃₁₃ in a direction (e.g., z-direction). In some embodiments, the thickness H₃₁₃ of the sill 313 is less than the thickness H_{312A} of the first side plate 312A, such that an outer surface of the sill 313 is lower than an outer surface of the first side plate 312A. This ensures that the hook HK of the engaging part LT can more easily cross over the sill 313 and enter the opening OP as the second connector 320 and the first connector 310 are combined toward each other.

Hereinafter, the structure and function of each component included in a connector assembly 400 of this embodiment and the connection relationship between the components will be described in detail.

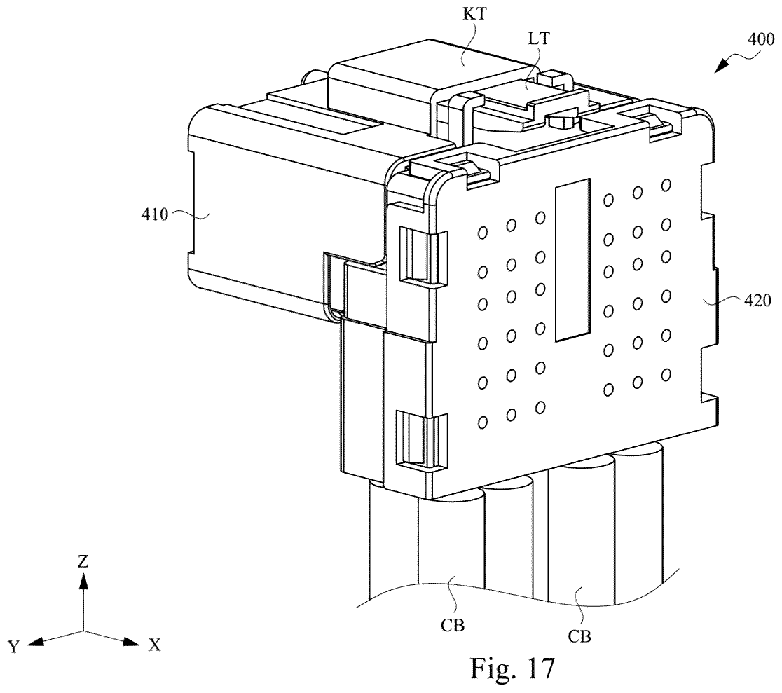

Reference is made to FIG. 17. FIG. 17 is a perspective view of a connector assembly 400 in accordance with an embodiment of the present disclosure. As shown in FIG. 17, in this embodiment, the connector assembly 400 includes a first connector 410 and a second connector 420. The second connector 420 can be coupled to the first connector 410. The connector assembly 400 of this embodiment can transmit larger current compared to the aforementioned embodiments. The differences between this embodiment and the aforementioned embodiments are described below.

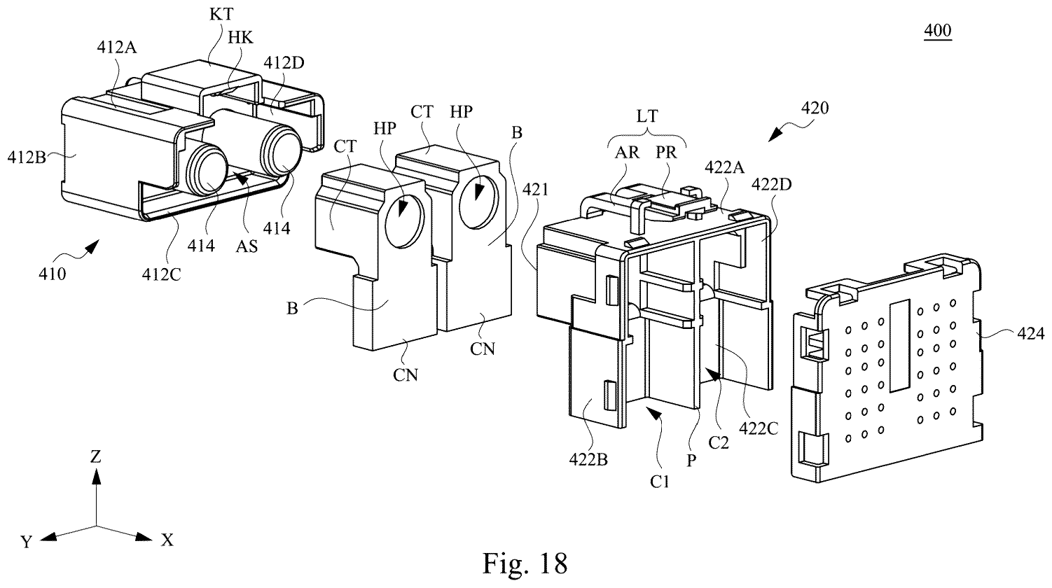

In this embodiment, the first connector 410 includes a pocket portion KT located on a surface of the first connector 410. The second connector 420 includes an engaging part LT located on a surface of the second connector 420. As shown in FIG. 17, when the first connector 410 is coupled to the second connector 420, the engaging part LT enters and is engaged with the pocket portion KT. The second connector 420 is fixed to the first connector 410 by the engaging part LT and the pocket portion KT. In a usage scenario, the first connector 410 and the second connector 420 are coupled to each other along a direction (e.g., x-direction). As shown in FIG. 17, in a usage scenario, a plurality of cables CB are connected to second conductive terminals B (as shown in FIG. 18).

Reference is made to FIG. 18. FIG. 18 is an exploded view of the connector assembly 400 in accordance with an embodiment of the present disclosure. As shown in FIG. 18, a width of a first side plate 412C in x-direction is less than a width of a first side plate 412A in x-direction. The pocket portion KT includes a hook HK on an inner surface of the pocket portion KT. The engaging part LT of the second connector 420 includes a pressing portion PR and an elastic arm AR. The elastic arm AR has a bump (or an opening) which is transversally extended. The engaging part LT is engaged with the hook HK of the pocket portion KT of the first connector 410 by the bump (or the opening) of the elastic arm AR. An end (a fixed end) of the elastic arm AR is connected to a second side plate 422A, and the pressing portion PR is located at the other end (a free end) of the elastic arm AR.

Reference is made again to FIG. 18. As shown in FIG. 18, in this embodiment, two second conductive terminals B are respectively located in the first cavity C1 and the second cavity C2. The second conductive terminal B includes a contacting portion CT and a connecting portion CN. The connecting portion CN is tabular, connected to the contacting portion CT, and extends toward negative z-direction perpendicular to a central axis of the hollowed portion HP. In some embodiments, a first portion of the first cavity C1 or the second cavity C2 extends in a direction (e.g., x-direction), and a second portion of the first cavity C1 or the second cavity C2 extends in a direction (e.g., z-direction). In other words, the first cavity C1 and the second cavity C2 are L-shaped. The contacting portion CT of the second conductive terminal B is located in the first portion of the first cavity C1 or the second cavity C2, whereas the connecting portion CN of the second conductive terminal B is located in the second portion of the first cavity C1 or the second cavity C2. In y-direction, a width of the connecting portion CN of the second conductive terminal B is greater than a width of the contacting portion CT of the second conductive terminal B. Therefore, the connecting portion CN in this embodiment has a larger area compared to the aforementioned embodiments, so as to connect more cables CB.

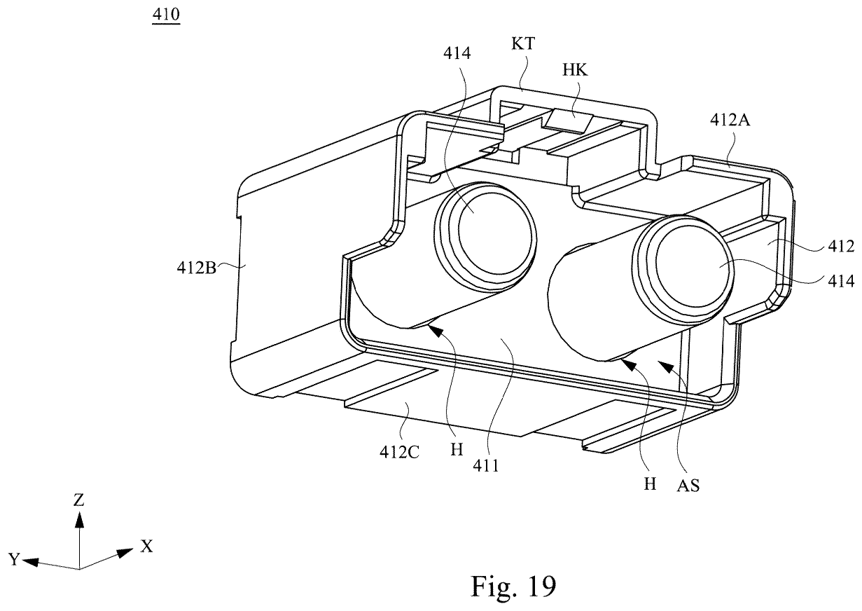

Reference is made to FIG. 19. FIG. 19 is a perspective view of a first connector 410 in accordance with an embodiment of the present disclosure. As shown in FIG. 19, the pocket portion KT protrudes from the first side plate 412A. The hook HK is disposed on the inner surface of the pocket portion KT and extends toward the accommodating space AS. In some embodiments, the pocket portion KT protrudes from the first side plate 412A to form a space that communicates with the accommodating space AS. In other words, the space formed by the pocket portion KT can be regarded as an extending portion of the accommodating space AS. In a usage scenario, the pocket portion KT is configured to accommodate the engaging part LT.

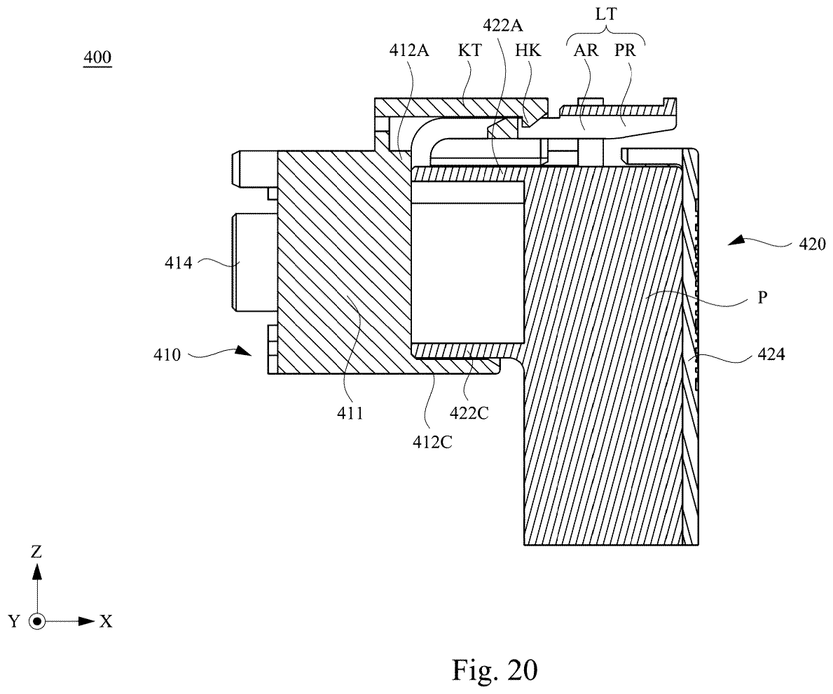

Reference is made to FIG. 20. FIG. 20 is a cross-sectional view of the connector assembly 400 in accordance with an embodiment of the present disclosure. As shown in FIG. 20, in this embodiment, the second connector 420 is coupled to the first connector 410. In a usage scenario, when the second connector 420 and the first connector 410 are combined toward each other, the hook HK crosses over a portion of the elastic arm AR and enters an opening of the elastic arm AR, thereby achieving the engagement between the engaging part LT and the hook HK. Since a width of the first side plate 412C is less than a width of the first side plate 412A, the overall width of the connector assembly 400 in x-direction can be reduced as the side-exit second connector 420 is coupled to the first connector 410.

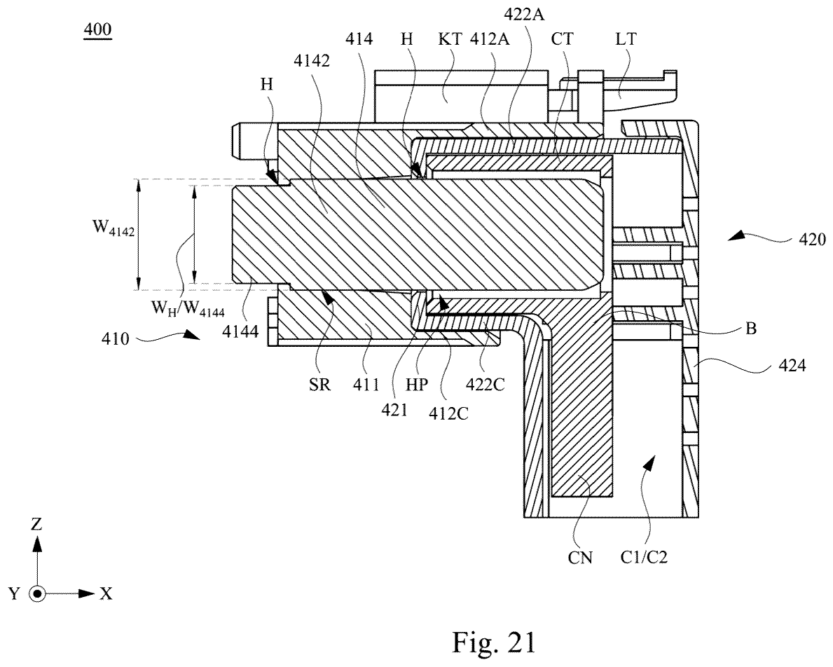

Reference is made to FIG. 21. FIG. 21 is a cross-sectional view of the connector assembly 400 in accordance with an embodiment of the present disclosure. As shown in FIG. 21, the first conductive terminal 414 includes a terminal main body 4142 and an exposing portion 4144. The exposing portion 4144 is located at a bottom end of the first conductive terminal 414 and is exposed on a surface of the first bottom plate 411. The first conductive terminal 414 passes through the hole H of the second bottom plate 421 and enters the hollowed portion HP of the second conductive terminal B. The terminal main body 4142 has a width W₄₁₄₂ in a direction (e.g., y-direction). In some embodiments in which the terminal main body 4142 is cylindrical, the width W₄₁₄₂ is a diameter of the terminal main body 4142. The diameter of the terminal main body 4142 can be increased to transmit larger current compared to the aforementioned embodiments. The exposing portion 4144 has a width W₄₁₄₄ in a direction (e.g., y-direction). In some embodiments in which the exposing portion 4144 is cylindrical, the width W₄₁₄₄ is a diameter of the exposing portion 4144. The hole H on an outer surface of the first bottom plate 411 has a minimum width W_{H} in a direction (e.g., y-direction). In some embodiments in which the hole H is circular, the minimum width W_{H} of the hole H is a minimum diameter of the hole H. In other words, the diameter of the hole H varies along x-direction. As shown in FIG. 21, in some embodiments, the width W₄₁₄₂ of the terminal main body 4142 is greater than the width W₄₁₄₄ of the exposing portion 4144. In some embodiments, the width W₄₁₄₂ of the terminal main body 4142 is greater than the minimum width W_{H} of the hole H of the first bottom plate 411, and the width W₄₁₄₄ of the exposing portion 4144 is less than the minimum width W_{H} of the hole H. This allows the exposing portion 4144 to pass through the hole H and be exposed on an outer side of the first bottom plate 411 and an end of the terminal main body 4142 is fixed in the hole H as the first conductive terminal 414 is inserted into the hole H of the first bottom plate 411 from the accommodating space AS.

Hereinafter, the structure and function of each component included in a connector assembly 500 of this embodiment and the connection relationship between the components will be described in detail.

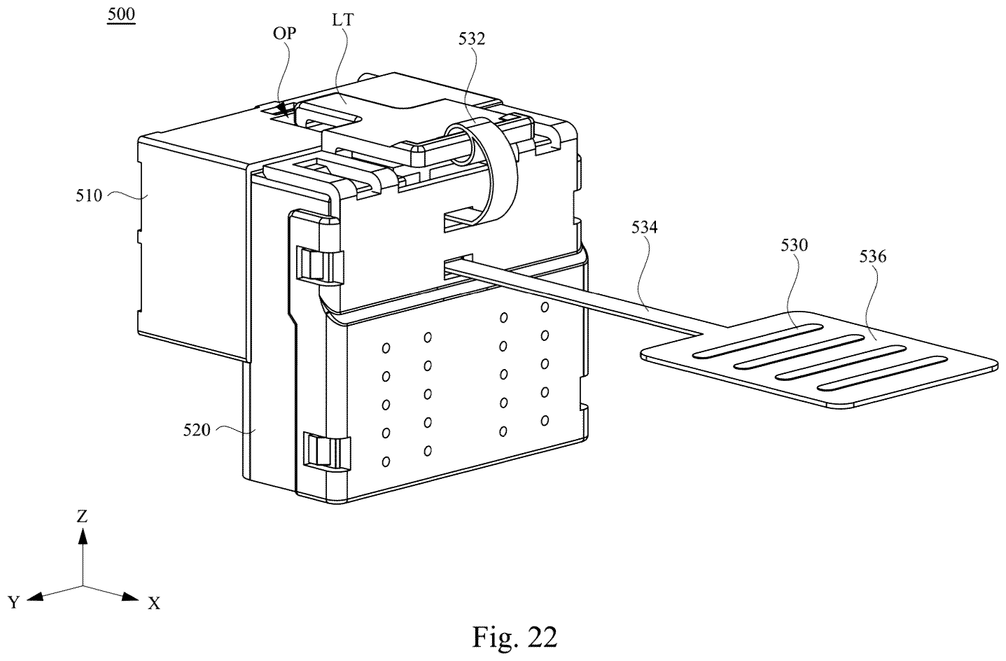

Reference is made to FIG. 22. FIG. 22 is a perspective view of a connector assembly 500 in accordance with an embodiment of the present disclosure. As shown in FIG. 22, in this embodiment, the connector assembly 500 includes a first connector 510, a second connector 520, and a pull belt 530. The second connector 520 can be coupled to the first connector 510. The pull belt 530 passes through the second connector 520. Specifically, the pull belt 530 includes a binding portion 532, a strip portion 534, and a pull tab 536. The strip portion 534 is connected between the binding portion 532 and the pull tab 536. The binding portion 532 binds an engaging part LT of the second connector 520. The strip portion 534 winds inward and outward the second connector 520. The pull tab 536 is located out of the second connector 520. As shown in FIG. 22, the engaging part LT is located on an outer side of an opening OP of the first connector 510 and is capable of being engaged with the opening OP.

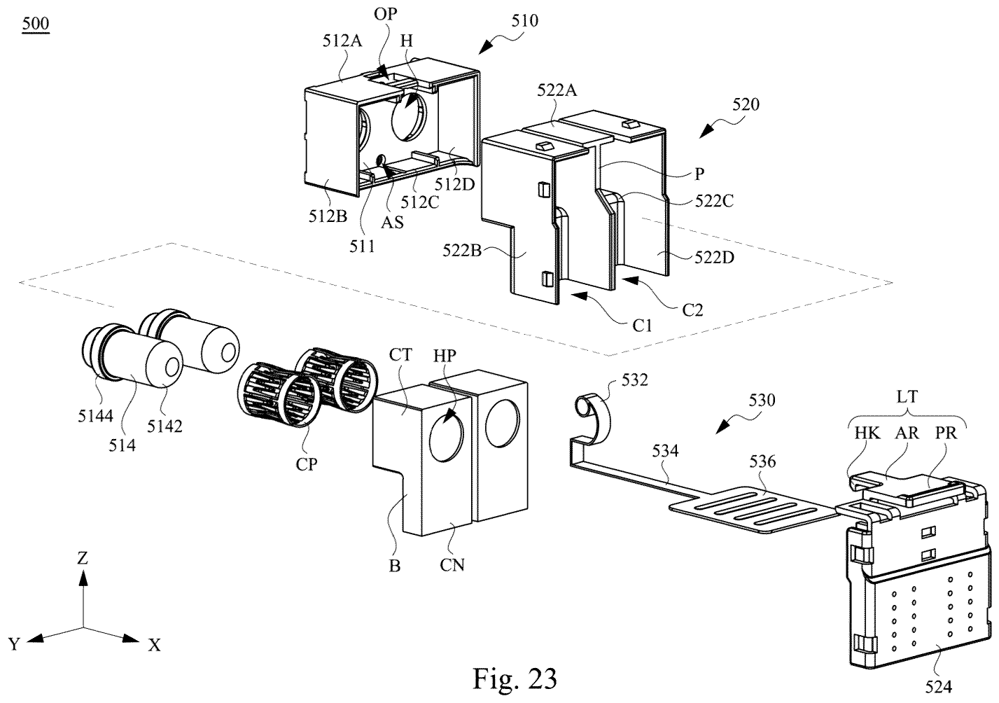

Reference is made to FIG. 23. FIG. 23 is an exploded view of the connector assembly 500 in accordance with an embodiment of the present disclosure. As shown in FIG. 23, in this embodiment, an insulating housing of the first connector 510 includes a first bottom plate 511, four first side plates 512A, 512B, 512C, and 512D, and two first conductive terminals 514. The first bottom plate 511 and the four first side plates 512A, 512B, 512C, and 512D jointly define an accommodating space AS. The first connector 510 further has holes H running through the first bottom plate 511. Each of the two first conductive terminals 514 includes a terminal main body 5142 and a blocking portion 5144. An insulating housing of the second connector 520 includes four second side plates 522A, 522B, 522C, and 522D, a partitioning portion P, two (or more) second conductive terminals B, and a cover plate 524. The partitioning portion P, the second side plates 522A, 522B, and 522C, and the cover plate 524 jointly define a first cavity C1, and the partitioning portion P, the second side plates 522A, 522C, and 522D, and the cover plate 524 jointly define a second cavity C2. The engaging part LT extends from one edge of the cover plate 524 and includes a pressing portion PR, an elastic arm AR, and a hook HK. The engaging part LT is substantially perpendicular to the cover plate 524, and the engaging part LT and the cover plate 524 may be integrally formed.

Reference is made again to FIG. 23. As shown in FIG. 23, in this embodiment, the connector assembly 500 further includes two crown springs CP. The two crown springs CP respectively sleeve the two first conductive terminals 514. The two second conductive terminals B are respectively located in the first cavity C1 and the second cavity C2. Each of the two second conductive terminal B includes a contacting portion CT and a connecting portion CN. The connecting portion CN is tabular, connected to the contacting portion CT, and extends toward negative z-direction perpendicular to a central axis of the hollowed portion HP. In some embodiments, a first portion of the first cavity C1 or the second cavity C2 extends in a direction (e.g., x-direction), and a second portion of the first cavity C1 or the second cavity C2 extends in a direction (e.g., z-direction). In other words, the first cavity C1 and the second cavity C2 are L-shaped. The contacting portion CT of the second conductive terminal B is located in the first portion of the first cavity C1 or the second cavity C2, whereas the connecting portion CN of the second conductive terminal B is located in the second portion of the first cavity C1 or the second cavity C2. In some embodiments, the two crown springs CP respectively wrap the two first conductive terminals 514 and located in the hollowed portion HP.

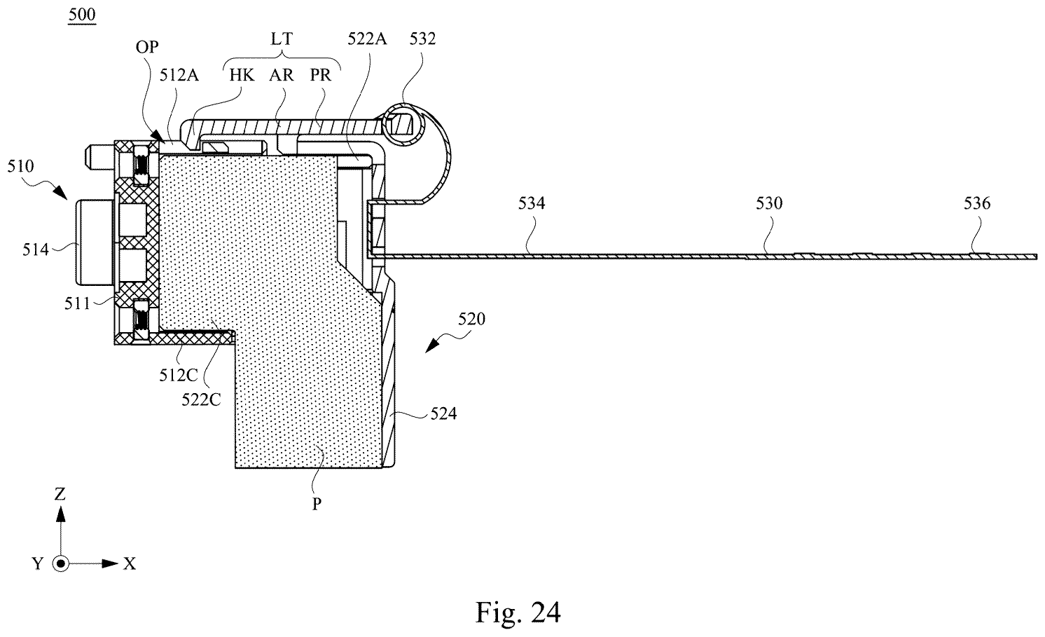

Reference is made to FIG. 24. FIG. 24 is a cross-sectional view of the connector assembly 500 in accordance with an embodiment of the present disclosure. As shown in FIG. 24, in this embodiment, the second connector 520 is coupled to the first connector 510. In a usage scenario, when the second connector 520 and the first connector 510 are combined toward each other, the hook HK enters the opening OP, thereby achieving the engagement between the engaging part LT and the opening OP. In another usage scenario, when the user grabs the pull tab 536 toward a direction away from the second connector 520, the binding portion 532 pulls the pressing portion PR toward the second side plate 522A. As such, the elastic arm AR seesaws relative the second side plate 522A, such that the hook HK of the engaging part LT escapes from the opening OP. By the aforementioned structural configuration, the user can disengage the first connector 510 and the second connector 520 more easily. In some embodiments, the pull tab 536 is omitted and the user directly pushes the pressing portion PR to disengage the first connector 510 and the second connector 520.

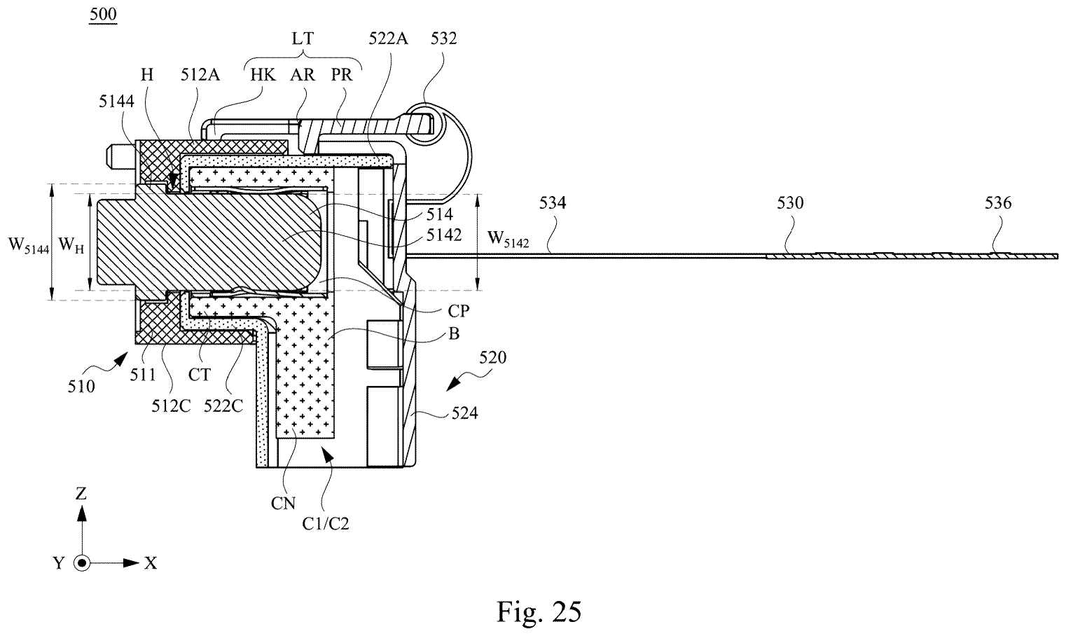

Reference is made to FIG. 25. FIG. 25 is a cross-sectional view of the connector assembly 500 in accordance with an embodiment of the present disclosure. As shown in FIG. 25, in this embodiment, the second connector 520 is coupled to the first connector 510, and the second connector 520 is partially located in the accommodating space AS of the first connector 510. Each of the two first conductive terminals 514 enters the hollowed portion HP of the second conductive terminal B. The terminal main body 5142 has a width W₅₁₄₂ in a direction (e.g., z-direction). In some embodiments in which the terminal main body 5142 is cylindrical, the width W₅₁₄₂ of the terminal main body 5142 is a diameter of the terminal main body 5142. The blocking portion 5144 has a width W₅₁₄₄ in a direction (e.g., z-direction). In some embodiments in which the blocking portion 5144 is disk-shaped, the width W₅₁₄₄ of the blocking portion 5144 is a diameter of the blocking portion 5144. The hole H on an inner surface of the first bottom plate 511 has a minimum width W_{H} in a direction (e.g., z-direction). As shown in FIG. 25, in some embodiments, the width W₅₁₄₂ of the terminal main body 5142 is less than the width W₅₁₄₄ of the blocking portion 5144 and is also less than the minimum width W_{H} of the hole H. In some embodiments, the width W₅₁₄₄ of the blocking portion 5144 is greater than the minimum width W_{H} of the hole H on the first bottom plate 511. This allows the two first conductive terminals 514, along x-direction, to be inserted into the hole H from an outer side of the insulating housing of the first connector 510. After an end of each of the two first conductive terminals 514 enters the accommodating space AS, the blocking portion 5144 is blocked and fixed on the hole H, so that the other end of each of the two first conductive terminals 514 is exposed at the outer side of the insulating housing of the first connector 510.

From the above detailed description of the specific embodiments of the present disclosure, it can be clearly seen that in the connector assembly of the present disclosure, since a terminal main body of the first conductive terminal passes through the hole of the first bottom plate and a width of a blocking portion is greater than the width of the hole, the first conductive terminal is fixed to the hole. In the connector assembly of the present disclosure, since the convex bars are disposed on the inner surface of a channel of the first bottom plate and the convex bars abut against the terminal main body of the first conductive terminal, the first conductive terminal can be prevented from being disengaged from the first bottom plate as the second connector is pulled out by an external force. In the connector assembly of the present disclosure, since the engaging part of the second connector is engaged with the opening of the first connector, the second connector is less likely to be disengaged from the first connector when being coupled to each other. In the connector assembly of the present disclosure, since the sill is located on the first side plate and communicates with the opening and a thickness of the sill is less than a thickness of the first bottom plate, the size of the second connector can be smaller. The engaging part can more easily enter the opening through the relatively lower sill as the second connector is coupled to the first connector, thereby achieving a purpose of easier assembling while ensuring the strengthening of the fixation between the two connectors. In the connector assembly of the present disclosure, since the connector assembly includes a plug, the plug blocks the movement of the second conductive terminal in an extending direction of the second conductive terminal to be disengaged from the second connector. In the connector assembly of the present disclosure, since the first conductive terminal includes a locking portion between the expanding portion and the blocking portion, and the width of the plug is less than that of the locking portion, the plug can clamp the locking portion. In summary, the connector assembly of the present disclosure not only reduces the size of the connector but also enables the transmission of larger current, but also achieves the effect of stabilizing the structure of the entire connector assembly.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A connector assembly, comprising:
a first connector, comprising:
a first bottom plate;
a plurality of first side plates surrounding and connected to sides of the first bottom plate, and the first side plates and the first bottom plate jointly defining an accommodating space; and
a first conductive terminal fixed to the first bottom plate and extending along a first direction in the accommodating space; and
a second connector configured to be coupled to the first connector and partially accommodated in the accommodating space, the second connector comprising:
a second bottom plate;
a plurality of second side plates surrounding and connected to sides of the second bottom plate, and the second side plates and the second bottom plate forming at least one cavity; and
a second conductive terminal located in the at least one cavity and extending along the first direction, the second conductive terminal comprising a contacting portion and a connecting portion connected to the contacting portion, wherein the contacting portion has a hollowed portion, and the first conductive terminal is able to enter the hollowed portion to be electrically connected to the second conductive terminal, wherein the connecting portion is tabular and is parallel to a central axis of the hollowed portion.

2. The connector assembly of claim 1, wherein the second connector further comprises at least one partitioning portion located between opposite two of the second side plates, and the at least one partitioning portion extends along the first direction.

3. The connector assembly of claim 2, further comprising a plug detachable combined with one of the second side plates, wherein the contacting portion of the second conductive terminal is located between the plug and the second bottom plate.

4. The connector assembly of claim 1, wherein one of the first side plates has an opening, and the second connector further comprises an engaging part disposed on one of the second side plates, wherein the engaging part is located on an outer side of the opening and is engaged with the opening as the second connector is coupled to the first connector.

5. The connector assembly of claim 4, wherein the first connector further comprises a sill located at an end of one of the first side plates away from the first bottom plate, and the sill is located on a side of the opening.

6. The connector assembly of claim 5, wherein an outer surface of the sill is lower than an outer surface of the one of the first side plates.

7. The connector assembly of claim 4, wherein the engaging part comprises a pressing portion, an elastic arm, and a hook, and the pressing portion and the hook are located at two ends of the elastic arm.

8. The connector assembly of claim 7, wherein a width of the pressing portion is greater than a width of the elastic arm.

9. The connector assembly of claim 7, further comprising a pull belt passing through the second connector, and the pull belt comprising a binding portion binding the pressing portion of the engaging part, a pull tab located out of the second connector, and a strip portion connected between the binding portion and the pull tab and winding inward and outward the second connector.

10. The connector assembly of claim 1, wherein the first conductive terminal comprises a locking portion, and the locking portion is a recess portion, wherein the first connector comprises at least one plug entering the locking portion.

11. The connector assembly of claim 1, wherein the first bottom plate has a hole, and the hole has a diameter varying along the first direction to secure the first conductive terminal.

12. The connector assembly of claim 1, wherein the first bottom plate has a hole, and a plurality of convex bars are located on an inner surface of the hole to secure the first conductive terminal.

13. The connector assembly of claim 1, wherein the second connector further comprises a crown spring, and the crown spring is disposed in the hollowed portion of the contacting portion of the second conductive terminal.

14. The connector assembly of claim 1, wherein the second connector further comprises a cover plate, and the cover plate is connected to a portion of the second side plates, such that the second conductive terminal is secured between the cover plate and the second bottom plate.

15. The connector assembly of claim 1, wherein the first connector further comprises another first conductive terminal fixed to the first bottom plate and extending in the accommodating space along the first direction, and the second connector further comprises another second conductive terminal located in the at least one cavity and extending along the first direction.

16. The connector assembly of claim 1, wherein the first connector further comprises a pocket portion disposed on one of the first side plates, and the pocket portion protrudes from the one of the first side plates, and the second connector further comprises an engaging part disposed on one of the second side plates, and the engaging part is engaged with the pocket portion.

17. A connector assembly, comprising:
a first connector, comprising:
a first bottom plate having two holes;
a plurality of first side plates surrounding and connected to sides of the first bottom plate, and the first side plates and the first bottom plate jointly defining an accommodating space; and
two first conductive terminals respectively passing through the two holes of the first bottom plate and extending in the accommodating space along a first direction, wherein one of the first side plates, which is wider than at least another one of the first side plates, has an opening;
a second connector configured to be coupled to the first connector and partially accommodated in the accommodating space, the second connector comprising:
a second bottom plate abutting against the first bottom plate and having two holes;
a plurality of second side plates surrounding and connected to sides of the second bottom plate, and the second side plates and the second bottom plate forming at least one cavity;
two second conductive terminals located in the at least one cavity, and each of the two second conductive terminals comprising a contacting portion and a connecting portion connected to the contacting portion, the connecting portion being configured to be electrically connected to a cable, wherein the contacting portion has a hollowed portion, and the two first conductive terminals are able to enter the hollowed portions to be electrically connected to the two second conductive terminals; and
an engaging part disposed on one of the second side plates, and
the engaging part is engaged with the opening.

18. The connector assembly of claim 17, wherein the first connector further comprises a sill located on a side of the opening, and an outer surface of the sill is lower than an outer surface of the one of the first side plates.

19. The connector assembly of claim 17, wherein the connecting portion is tabular, and the connecting portion is parallel to a central axis of the hollowed portion.

20. The connector assembly of claim 17, wherein a first portion of the at least one cavity extends along the first direction, and a second portion of the at least one cavity extends along a second direction different from the first direction.

21. The connector assembly of claim 20, wherein the connecting portion is tabular, and the connecting portion is perpendicular to a central axis of the hollowed portion.

22. The connector assembly of claim 21, wherein the contacting portion of each of each of the two second conductive terminals is located in the first portion of the at least one cavity, and the connecting portion of each of the two second conductive terminals is located in the second portion of the at least one cavity.

23. The connector assembly of claim 17, wherein the at least another one of the first side plates has at least one convex rib disposed on an inner surface thereof.

24. The connector assembly of claim 17, further comprising a pull belt passing through the second connector, and the pull belt comprising a binding portion binding a pressing portion of the engaging part, a pull tab located out of the second connector, and a strip portion connected between the binding portion and the pull tab and winding inward and outward the second connector.
